(19) United States
(12) Patent Application Publication
(10) Pub. No.: US 2026/0233504 A1
(43) Pub. Date: Aug. 13, 2026

(54) BIAXIALLY ORIENTED POLYPROPYLENE FILM AND LAMINATED BODY INCLUDING THE SAME

(71) Applicant: TOYOBO CO., LTD., Osaka-shi, Osaka (JP)

(72) Inventors: Atsushi KANAYA, Inuyama (JP); Toru IMAI, Inuyama (JP)

(73) Assignee: TOYOBO CO., LTD., Osaka-shi, Osaka (JP)

(21) Appl. No.: 19/149,942

(22) PCT Filed: Jan. 10, 2024
(86) PCT No.: PCT/JP2024/000253

§ 371 Date: Jul. 22, 2025

(30) Foreign Application Priority Data
Jan. 30, 2023 (JP) 2023-012346

(51) Int. Cl. B32B 27/32; B32B 27/08; B32B 27/16; B32B 27/18; C08L 23/12; C08L 23/14

(52) U.S. Cl. CPC B32B 27/32; B32B 27/08; B32B 27/16; B32B 27/18; C08L 23/12; C08L 23/142; B32B 2250/242; B32B 2307/518; B32B 2307/536; B32B 2307/538; B32B 2307/70; B32B 2307/736; B32B 2439/70; B32B 2519/00; C08L 2203/16

(57) ABSTRACT

It is an object of the present invention to provide a biaxially oriented polypropylene film that has high thermal dimensional stability and high mechanical strength, and that also has high workability when a functional layer such as a vapor-deposited layer or a coating layer is formed on the film, as well as high adhesion to the functional layer. A biaxially oriented polypropylene film comprising a base layer A containing a polypropylene resin composition; and a surface layer B containing a polypropylene resin composition provided on one surface of the base layer A, wherein the film satisfies the following (1) to (4): (1) a Martens hardness of the surface layer B is 248 N/mm² or less; (2) a wetting tension of the surface layer B is 36 mN/m or more; (3) a sum of a heat shrinkage rate at 150° C. in a longitudinal direction and a heat shrinkage rate at 150° C. in a width direction is 0.0% or more and 25.0% or less; and (4) a fall-off rate of an anti-blocking agent in the surface layer B is 10% or less.

### TECHNICAL FIELD

The present invention relates to a biaxially oriented polypropylene film and a laminated body including the same.

### BACKGROUND ART

Conventionally, biaxially oriented polypropylene films have been widely used as materials for packaging articles such as foodstuffs and textile products because the biaxially oriented polypropylene films have high transparency and excellent mechanical properties. However, since biaxially oriented polypropylene films exhibit poor slipperiness and tend to cause blocking, in which films stick to each other, in some cases, workability during film processing may be impaired. The addition of an anti-blocking agent is known as a means to address such problems.

With respect to printing on the biaxially oriented polypropylene film, from the viewpoint of print quality and resistance to fading, there are demands for improving the transferability of a printing ink from a printing roll to a film surface and the adhesion of the printing ink to the film surface. However, in some cases, since a polypropylene resin is non-polar and thus has low surface energy, biaxially oriented polypropylene films exhibit insufficient adhesion to a vapor-deposited layer, a coating layer, a printing ink, and the like.

As an example of a film having improved adhesion to a printing ink, Patent Document 1 discloses a film that includes a surface layer with predetermined surface roughness and wetting tension by containing an anti-blocking agent.

As an example of a film having high adhesion to an aluminum vapor-deposited layer when the aluminum vapor-deposited layer is provided on a surface layer, Patent Document 2 discloses a film that includes a surface layer with relatively low surface roughness and predetermined wetting tension by containing an anti-blocking agent.

### CITATION LIST

### Patent Document

Patent Document 1: WO 2018/142983
Patent Document 2: WO 2022/004340

### SUMMARY OF THE INVENTION

### Problems to be Solved by the Invention

However, the film disclosed in Patent Document 1 exhibits inferior adhesion to an aluminum vapor-deposited layer when the aluminum vapor-deposited layer is provided on the surface layer. Also, the film disclosed in Patent Document 2 exhibits inferior film formability due to unstable longitudinal stretching, and the resulting film exhibits poor appearance and unstable physical properties.

It is an object of the present invention to provide a biaxially oriented polypropylene film that has high thermal dimensional stability, high mechanical strength, and excellent appearance, and that also has high workability when a functional layer such as a vapor-deposited layer or a coating layer is formed on the film, as well as high adhesion to the functional layer.

### Solution to the Problems

As a result of earnest studies to achieve the above objective, the above problem has been solved by providing a biaxially oriented polypropylene film including a base layer A containing a polypropylene resin composition and a surface layer B containing a polypropylene resin composition provided on one surface of the base layer A, and by controlling the composition of the polypropylene resin composition used in the surface layer B and film forming conditions. That is, the present invention has the following configurations.

[1] A biaxially oriented polypropylene film comprising:
a base layer A containing a polypropylene resin composition; and
a surface layer B containing a polypropylene resin composition provided on one surface of the base layer A,
wherein the film satisfies the following (1) to (4):
(1) a Martens hardness of the surface layer B is 248 N/mm² or less;
(2) a wetting tension of the surface layer B is 36 mN/m or more;
(3) a sum of a heat shrinkage rate at 150° C. in a longitudinal direction and a heat shrinkage rate at 150° C. in a width direction is 0.0% or more and 25.0% or less; and
(4) a fall-off rate of an anti-blocking agent in the surface layer B is 10% or less.

[2] The biaxially oriented polypropylene film according to the above [1], wherein the surface layer B has a surface resistance value of 14.0 Log Ω or more.

[3] The biaxially oriented polypropylene film according to the above [1] or [2], wherein the surface layer B has a three-dimensional average roughness SRa of 10 nm or more.

[4] The biaxially oriented polypropylene film according to any one of the above [1] to [3], wherein the surface layer B contains a polypropylene resin having a melting point of 130° C. or higher and 158° C. or lower in an amount of 25% by mass or more and 85% by mass or less.

[5] The biaxially oriented polypropylene film according to any one of the above [1] to [4], wherein the film further comprises a surface layer C on the other surface of the base layer A, and the surface layer C contains a polypropylene resin composition containing an anti-blocking agent.

[6] The biaxially oriented polypropylene film according to the above [5], wherein the surface layer C has a three-dimensional average roughness SRa of 15 nm or more and a fall-off rate of the anti-blocking agent in the surface layer C is 10% or less.

[7] The biaxially oriented polypropylene film according to the above [5] or [6], wherein the surface layer C has a wetting tension of 36 mN/m or more.

[8] A laminated body comprising the biaxially oriented polypropylene film according to any one of the above [1] to [7] and a functional layer provided on the surface layer B of the film.

[9] A laminated body comprising the biaxially oriented polypropylene film according to any one of the above [1] to [7] and an unstretched polyolefin film.

[10] A laminated body further comprising an unstretched polyolefin film provided on the functional layer of the laminated body according to the above [8].

### Effects of the Invention

According to the present invention, a biaxially oriented polypropylene film that exhibits high thermal dimensional stability and excellent mechanical strength can be obtained. Furthermore, a biaxially oriented polypropylene film that exhibits high workability when a functional layer such as a vapor-deposited layer or a coating layer is formed on the film, and that also exhibits enhanced adhesion to the functional layer, can be stably obtained. In addition, when a layer of metal and/or metal oxide is provided on the biaxially oriented polypropylene film of the present invention, a laminated body that exhibits high gas barrier properties can be obtained.

### DESCRIPTION OF EMBODIMENTS

The biaxially oriented polypropylene film of the present invention includes a base layer A containing a polypropylene resin composition and a surface layer B containing a polypropylene resin composition. Preferably, the biaxially oriented polypropylene film of the present invention further includes a surface layer C. Specifically, the biaxially oriented polypropylene film preferably bas the surface layer B on one surface of the base layer A and the surface layer C on the other surface of the base layer A.

The biaxially oriented polypropylene film of the present invention satisfies the following (1) to (4). Hereinafter, “the biaxially oriented polypropylene film of the present invention” is referred to as merely “film” in some cases.

(1) A Martens hardness of the surface layer B is 248 N/mm² or less.

(2) A wetting tension of the surface layer B is 36 mN/m or more.

(3) A sum of a heat shrinkage rate at 150° C. in the longitudinal direction and a heat shrinkage rate at 150° C. in the width direction is 0.0% or more and 25.0% or less.

(4) A fall-off rate of an anti-blocking agent in the surface layer Bis 10% or less.

### (1) Base Layer A

The base layer A of the biaxially oriented polypropylene film of the present invention preferably improves the thermal dimensional stability, the mechanical strength, and the transparency of the film.

The base layer A is formed from a polypropylene resin composition containing a polypropylene homopolymer as a main constituent component. The term “main constituent component” as used in the present invention means that the polypropylene homopolymer accounts for 70% by mass or more, more preferably 80% by mass or more, further preferably 90% by mass or more, and particularly preferably 95% by mass or more of the total base layer A.

### (Polypropylene Homopolymer)

The polypropylene homopolymer used in the base layer A is a polypropylene polymer that is substantially free from an α-olefin component other than propylene, and is specifically a polypropylene (co) polymer containing 1 mol % or less of an α-olefin component other than propylene and 99 mol % or more of propylene as constituent units. Throughout the present specification, a polypropylene homopolymer includes not only a polypropylene homopolymer entirely free from an α-olefin component other than propylene, but also a polypropylene copolymer containing 1 mol % or less of an α-olefin component other than propylene and 99 mol % or more of propylene as constituent units. Even if an α-olefin component other than propylene is contained, the content of the α-olefin component other than propylene (the total amount of ethylene and an α-olefin having four or more carbon atoms) is 1 mol % or less as described above, preferably 0.3 mol % or less, more preferably 0.2 mol % or less, and further preferably 0.1 mol % or less. The content within the above range is likely to improve the crystallinity.

Examples of the α-olefin component having four or more carbon atoms include 1-butene, 1-pentene, 3-methyl-1-pentene, 3-methyl-1-butene, 1-hexene, 4-methyl-1-pentene, 5-ethyl-1-hexene, 1-octene, 1-decene, 1-dodecene, 1-tetradecene, 1-hexadecene, 1-heptadecene, 1-octadecene, and 1-eicosene.

As the polypropylene homopolymer, two or more different types of the polypropylene homopolymers may be used.

Hereinafter, preferred physical properties of the polypropylene homopolymer will be described. When two or more different types of polypropylene homopolymers are used, mass-averages of the physical properties of each polypropylene homopolymer are preferably within the numerical ranges described below.

The polypropylene homopolymer used in the base layer A preferably has a melting point of 160° C. or higher and 175° C. or lower, more preferably 164° C. or higher and 173° C. or lower, and further preferably 166° C. or higher and 171° C. or lower. The melting point of 160° C. or higher can enhance the thermal dimensional stability and the mechanical strength. The melting point of 175° C. or lower may help suppress an increase in polypropylene production cost, and reduce breakage during film formation. The melting point can be further increased by blending a crystal nucleating agent into the polypropylene resin.

The melting point is a main peak temperature of an endothermic peak associated with melting, as observed using a differential scanning calorimeter (DSC), when 1 mg to 10 mg of a sample placed in an aluminum sample pan and set in the instrument is, under a nitrogen atmosphere, melted at 230° C. for 5 minutes, then cooled to 30° C. at a scanning rate of −10° C./min and held for 5 minutes, and subsequently heated at a scanning rate of 10° C./min.

The polypropylene homopolymer used in the base layer A has a mesopentad fraction ([mmmm] %), which is an index of stereoregularity, of preferably from 95.0% to 99.9%, more preferably from 97.0% to 99.7%, further preferably from 97.5% to 99.5%, and particularly preferably from 98.0% to 99.3%. When the mesopentad fraction is 95.0% or more, the crystallinity of the polypropylene resin may be increased. The increase in the crystallinity allows for improvements in the melting point, the degree of crystallization, and the degree of crystalline orientation of crystals in the base layer A. As a result, thermal dimensional stability and the mechanical strength can be enhanced. When the mesopentad fraction is 99.9% or less, the production cost of the polypropylene is readily reduced, and breakage during film formation may decrease. The mesopentad fraction is measured by nuclear magnetic resonance spectroscopy (so-called NMR method).

The polypropylene homopolymer used in the base layer A has a melt flow rate (MFR), as measured in accordance with condition M (230° C., 2.16 kgf) described in JIS K 7210:1995, of preferably from 4.0 g/10 min to 30 g/10 min, more preferably from 4.5 g/10 min to 25 g/10 min, further preferably from 4.8 g/10 min to 22 g/10 min, particularly preferably from 5.0 g/10 min to 20 g/10 min, and most preferably from 5.5 g/10 min to 10 g/10 min.

When the polypropylene resin has an MFR of 4.0 g/10 min or more, the amount of low-molecular-weight components in the polypropylene resin constituting the base layer A increases. As a result, oriented crystallization of the polypropylene resin may be further promoted, the degree of crystallization in the base layer A may be further enhanced, and the polypropylene molecular chain entanglement in the amorphous regions may further decrease. Accordingly, the thermal dimensional stability and the mechanical strength can be enhanced. On the other hand, when the MFR of the polypropylene resin is 30 g/10 min or less, it becomes easier to maintain film formability.

The polypropylene homopolymer used in the base layer A has a weight-average molecular weight (Mw) of preferably from 180,000 to 500,000. If the Mw is less than 180,000, the melt viscosity becomes low, casting may become unstable, and the film formability may deteriorate. If the Mw is more than 500,000, the amount of components having a molecular weight of 100,000 or less decreases, and the heat shrinkage rate at high temperature may decrease. The Mw is more preferably from 190,000 to 400,000, further preferably from 200,000 to 380,000, and particularly preferably from 210,000 to 350,000.

The polypropylene homopolymer used in the base layer A has a number-average molecular weight (Mn) of preferably from 20,000 to 200,000. If the Mn is less than 20,000, the melt viscosity becomes low, casting may become unstable, and the film formability may deteriorate. If the Mn is more than 200,000, the heat shrinkage rate at high temperature may decrease. The Mn is more preferably from 30,000 to 120,000, further preferably from 40,000 to 110,000, particularly preferably from 50,000 to 100,000, and most preferably from 60,000 to 90,000.

The polypropylene homopolymer used in the base layer A has an Mw/Mn, which is an indicator of molecular weight distribution, of preferably 2.8 or more and 10 or less, more preferably 3.0 or more and 8.0 or less, further preferably 3.2 or more and 6.0 or less, and particularly preferably 3.5 or more and 5.0 or less. When the polypropylene homopolymer has the Mw/Mn of 2.8 or more, the amount of low-molecular-weight components in the polypropylene resin constituting the base layer A increases. As a result, oriented crystallization of the polypropylene resin is further promoted, the degree of crystallization in the base layer A is further enhanced, and the polypropylene molecular chain entanglement in the amorphous regions further decrease. Accordingly, the thermal dimensional stability and the mechanical strength can be enhanced. The molecular weight distribution of the polypropylene homopolymer can be controlled by polymerizing components with different molecular weights in multiple stages within a single plant, by blending components having different molecular weights off-line using a kneader, by polymerizing with a blend of catalysts having different performances, or by using a catalyst capable of providing a desired molecular weight distribution.

(Components Other than Polypropylene Homopolymer)

The propylene resin composition constituting the base layer A may contain an additive and a resin other than the polypropylene homopolymer. Examples of the additive include antioxidants, ultraviolet absorbers, nucleating agents, adhesives, antifogging agents, flame retardants, and inorganic and organic fillers. Examples of the other resin include polyolefin resins excluding the polypropylene homopolymer used in the base layer A and various elastomers. These may be used by sequential polymerization using a multi-stage reactor, by blending with the polypropylene resin using a Henschel mixer, by diluting a previously prepared master pellet with polypropylene to predetermined concentrations using a melt kneader, or by melt-kneading a whole amount in advance. If the surface resistance value of the polypropylene resin alone used in the base layer A is excessively high, a surfactant may be added to reduce the surface resistance value.

### (2) Surface Layer B

The surface layer B preferably exhibits high adhesion to the functional layer when a functional layer such as a vapor-deposited layer or a coating layer is provided on the surface layer B, and it is also preferred that the slipperiness and the anti-blocking properties are imparted. The functional layer as used herein means a layer having at least one function from coating properties, design properties, water vapor barrier properties, oxygen barrier properties, heat conductivity, low dielectric properties, high dielectric properties, and heat resistance, and examples of the functional layer include a vapor-deposited layer, a coating layer, and a printing layer.

The surface layer B preferably contains a polypropylene resin having a melting point of 130° C. or higher and 158° C. or lower in an amount of 25% by mass or more and 85% by mass or less. In other words, the polypropylene resin composition constituting the surface layer B preferably contains the polypropylene resin having a melting point of 130° C. or higher and 158° C. or lower in an amount of 25% by mass or more and 85% by mass or less. Also, the surface layer B preferably contains a polypropylene resin having a melting point of 159° C. or higher and 175° C. or lower. However, the surface layer B preferably contains a small amount of a polypropylene resin having a melting point of 129° C. or lower, specifically, in an amount of preferably 20% by mass or less, more preferably 10% by mass or less, further preferably 5% by mass or less, particularly preferably 1% by mass or less, and most preferably 0% by mass (i.e., being free from the polypropylene resin having a melting point of 129° C. or lower). Hereinafter, the polypropylene resin having a melting point of 159° C. or higher and 175° C. or lower, the polypropylene resin having a melting point of 130° C. or higher and 158° C. or lower, and the polypropylene resin having a melting point of 129° C. or lower, as used in the surface layer B, are referred to as a “high-melting-point polypropylene resin”, a “medium-melting-point polypropylene resin”, and a “low-melting-point polypropylene resin”, respectively, in some cases. The polypropylene resin used in the surface layer B is classified into the high-melting-point polypropylene resin, the medium-melting-point polypropylene resin, or the low-melting-point polypropylene resin based on its melting point rounded to the nearest integer. Only one type or two or more different types of the polypropylene resins may be used for each of the high-melting-point polypropylene resin, the medium-melting-point polypropylene resin, and the low-melting-point polypropylene resin.

The content of 25% by mass or more and 85% by mass or less of the medium-melting-point polypropylene resin in the surface layer B can further enhance the adhesion to the vapor-deposited layer and the coating layer. The melting point of 158° C. or lower of the medium-melting-point polypropylene resin can enhance the adhesion to the functional layer. The melting point of 130° C. or higher ensures productivity during film formation, and can suppress surface roughening of the film. The medium-melting-point polypropylene resin has a melting point of preferably 134° C. or higher and 150° C. or lower, and more preferably 138° C. or higher and 143° C. or lower.

The content of the medium-melting-point polypropylene resin of 25% by mass or more can enhance the adhesion to the vapor-deposited layer and the coating layer. The content of the medium-melting-point polypropylene resin of 85% by mass or less ensures productivity during film formation, and can suppress surface roughening of the film. The surface layer B contains the medium-melting-point polypropylene resin in an amount of more preferably 30% by mass or more and 80% by mass or less, and further preferably 35% by mass or more and 75% by mass or less.

Meanwhile, in order to maintain the thermal dimensional stability and the mechanical strength of the biaxially oriented polypropylene film, the surface layer B preferably contains a high-melting-point polypropylene resin, which has a higher melting point than the medium-melting-point polypropylene resin. The high-melting-point polypropylene resin has a melting point of preferably 160° C. or higher and 170° C. or lower, and more preferably 161° C. or higher and 165° C. or lower. The surface layer B contains the high-melting-point polypropylene resin in an amount of preferably 15% by mass or more and 75% by mass or less, more preferably 20% by mass or more and 70% by mass or less, and further preferably 25% by mass or more and 65% by mass or less.

The total amount of the high-melting-point polypropylene resin and the medium-melting-point polypropylene resin is preferably from 60% by mass to 100% by mass, more preferably from 70% by mass to 100% by mass, further preferably from 80% by mass to 100% by mass, further more preferably from 90% by mass to 100% by mass, particularly preferably from 95% by mass to 100% by mass, and most preferably from 98% by mass to 100% by mass, based on the total resins contained in the surface layer B.

Hereinafter, preferred physical properties of the medium-melting-point polypropylene resin and the high-melting-point polypropylene resin will be described. When two or more different types of polypropylene resins are used as the medium-melting-point polypropylene resin, mass-averages of the physical properties of each polypropylene resin are preferably within the numerical ranges described below. When two or more different types of polypropylene resins are used as the high-melting-point polypropylene resin, mass-averages of the physical properties of each polypropylene resin are preferably within the numerical ranges described below.

The medium-melting-point polypropylene resin has a melt flow rate (MFR; 230° C., 2.16 kgf) of preferably 2.0 g/10 min or more and 10 g/10 min or less, more preferably 3.0 g/10 min or more and 8.0 g/10 min or less, and further preferably 4.0 g/10 min or more and 7.0 g/10 min or less. The high-melting-point polypropylene resin has a melt flow rate (MFR; 230° C., 2.16 kgf) of preferably 2.0 g/10 min or more and 10 g/10 min or less, and more preferably 3.0 g/10 min or more and 6.0 g/10 min or less. The difference between the MER of the medium-melting-point polypropylene resin and the MER of the high-melting-point polypropylene resin is preferably 2.0 g/10 min or less, and more preferably 1.5 g/10 min or less.

The medium-melting-point polypropylene resin has a weight-average molecular weight (Mw) of preferably from 180,000 to 500,000, more preferably from 190,000 to 320,000, further preferably from 200,000 to 300,000, and particularly preferably from 230,000 to 260,000. If the Mw is less than 180,000, the melt viscosity becomes low, casting may become unstable, and the film formability may deteriorate. If the Mw is more than 500,000, the amount of components having a molecular weight of 100,000 or less significantly decrease, and the heat shrinkage rate at high temperature may decrease.

The high-melting-point polypropylene resin bas an Mw of preferably from 180,000 to 500,000, more preferably from 210,000 to 400,000, further preferably from 240,000 to 350,000, and particularly from 270,000 to 320,000. If the Mw is less than 180,000, the melt viscosity becomes low, casting may become unstable, and the film formability may deteriorate. If the Mw is more than 500,000, the amount of components having a molecular weight of 100,000 or less significantly decrease, and the heat shrinkage rate at high temperature may decrease. The Mw of the high-melting-point polypropylene resin preferably exceeds the Mw of the medium-melting-point polypropylene resin.

The medium-melting-point polypropylene resin has a number-average molecular weight (Mn) of preferably from 20,000 to 200,000, more preferably from 30,000 to 80,000, further preferably from 40,000 to 70,000, and particularly preferably from 45,000 to 55,000. If the Mn is less than 20,000, the melt viscosity becomes low, casting may become unstable, and the film formability may deteriorate. If the Mn is more than 200,000, the heat shrinkage rate at high temperature may decrease.

The high-melting-point polypropylene resin has an Mn of preferably from 20,000 to 200,000, more preferably from 30,000 to 80,000, further preferably from 40,000 to 70,000, and particularly preferably from 50,000 to 60,000. If the Mn is less than 20,000, the melt viscosity becomes low, casting may become unstable, and the film formability may deteriorate. If the Mn is more than 200,000, the heat shrinkage rate at high temperature may decrease. The Mn of the high-melting-point polypropylene resin preferably exceeds the Mn of the medium-melting-point polypropylene resin.

The medium-melting-point polypropylene resin has a molecular weight distribution (Mw/Mn) of preferably 2.8 or more and 10 or less, more preferably 3.2 or more and 9.0 or less, further preferably 3.5 or more and 9.0 or less, particularly preferably 4.0 or more and 8.0 or less, and most preferably 4.5 or more and 6.0 or less. The high-melting-point polypropylene resin has a molecular weight distribution (Mw/Mn) of preferably 2.8 or more and 10 or less, more preferably 3.2 or more and 9.0 or less, further preferably 3.5 or more and 9.0 or less, particularly preferably 3.7 or more and 8.0 or less, and most preferably 4.0 or more and 6.0 or less. The Mw/Mn of the high-melting-point polypropylene resin preferably exceeds the Mw/Mn of the medium-melting-point polypropylene resin.

The high-melting-point polypropylene resin, the medium-melting-point polypropylene resin, and the low-melting-point polypropylene resin can be obtained by polymerizing propylene as a raw material using known catalysts such as Ziegler-Natta catalysts and metallocene catalysts. Although the medium-melting-point polypropylene resin having a melting point of 130° C. or higher and 158° C. or lower may be obtained by copolymerizing ethylene and/or an α-olefin having four or more carbon atoms or by using a polypropylene resin with decreased stereoregularity due to the catalyst used, the medium-melting-point polypropylene resin can be obtained without copolymerizing ethylene and/or an α-olefin having four or more carbon atoms. The content of an α-olefin component other than propylene (the total amount of ethylene and an α-olefin having four or more carbon atoms) is preferably from 0 mol % to 15 mol %, and more preferably from 2 mol % to 10 mol % in the medium-melting-point polypropylene resin.

From the viewpoint of imparting the slipperiness and the anti-blocking properties to the surface layer B, the surface layer B preferably contains an anti-blocking agent. Also, the surface layer B may contain additives other than the anti-blocking agent and a resin other than the polypropylene resin. Examples of the other additive include antioxidants, ultraviolet absorbers, nucleating agents, adhesives, antifogging agents, flame retardants, and inorganic and organic fillers. Examples of the other resin include polyolefin resins excluding the polypropylene resin used in the surface layer B and various elastomers. These may be used by sequential polymerization using a multi-stage reactor, by blending with the polypropylene resin using a Henschel mixer, by diluting a previously prepared master pellet with polypropylene to predetermined concentrations using a melt kneader, or by melt-kneading a whole amount in advance. The total amount of the high-melting-point polypropylene resin and the medium-melting-point polypropylene resin is preferably from 70% by mass to 100% by mass, more preferably from 80% by mass to 100% by mass, further preferably from 90% by mass to 100% by mass, particularly preferably from 95% by mass to 100% by mass, and most preferably from 98% by mass to 100% by mass based on the total resins contained in the surface layer B.

As the anti-blocking agent, particles having a pore volume of preferably from 0.2 mL/g to 3 mL/g, more preferably from 0.5 mL/g to 2.5 mL/g, and further preferably from 1.1 mL/g to 1.8 mL/g are used. The anti-blocking agent may be appropriately selected and used from inorganic and organic particles. Among them, the use of a silicon compound is particularly preferred. Examples of the silicon compound include silica, silicates, and compounds each having a main backbone formed by siloxane bonds. Among them, porous silica particles are particularly preferred. When porous silica particles are used, those having a pore volume of from 0.8 mL/g to 2 mL/g are preferred, and those having a pore volume of from 1.1 mL/g to 1.8 mL/g are more preferred.

The particle shape may be spherical or irregular, and irregular-shaped particles are preferably used. The particles have an average particle size of preferably 1 μm or more and 5 μm or less, and more preferably 2 μm or more and 4 μm or less. The average particle size is determined by capturing images with a scanning electron microscope, measuring the horizontal Feret's diameter using an image analysis device, and calculating the average.

The content of the anti-blocking agent is preferably 100 ppm or more and 10000 ppm or less, more preferably 300 ppm or more and 6000 ppm or less, further preferably 800 ppm or more and 4000 ppm or less, and particularly preferably 1200 ppm or more and 2700 ppm or less based on the total mass of the surface layer B. By adjusting the content within the above range, the three-dimensional average roughness and the Martens hardness of the surface layer B can be controlled within predetermined ranges described below. When the content is 100 ppm or more, the film exhibits high slipperiness and enhanced anti-blocking properties. When the content is 10000 ppm or less, it is less likely that excessive addition of the anti-blocking agent may result in decreased optical transparency, penetration of the anti-blocking agent through the functional layer during lamination of the functional layer, and sparse formation of the functional layer in the vicinity of the surface layer B which is caused by the anti-blocking agent protruding from the surface layer B; hence, the degradation of barrier properties and poor adhesion are unlikely to occur.

The fall-off rate of the anti-blocking agent in the surface layer B is 10% or less, preferably 8% or less, more preferably 6% or less, and further preferably 4% or less. When the fall-off rate is 10% or less, contamination of a guide roll during post-processing such as coating and vapor deposition can be suppressed. Furthermore, the occurrence of voids caused by falling off of the anti-blocking agent can be suppressed, and a laminated body having high gas barrier properties can be obtained when metal and/or metal oxide is vapor-deposited. The lower limit of the fall-off rate is not particularly limited, and is, for example, 0.3% or more.

### (3) Surface Layer C

The surface layer C, which is optionally provided, is a layer primarily intended to develop slipperiness and anti-blocking properties. The polypropylene resin used in the surface layer C has a melting point of preferably 150° C. or higher to maintain the thermal dimensional stability, the mechanical strength, and the productivity. A polypropylene resin having a melting point of 175° C. or lower can be easily and economically obtained, and, further, the falling off of the anti-blocking agent at the surface layer C can be prevented.

The surface layer C preferably contains a polypropylene resin composition including a polypropylene resin having a melting point of 150° C. or higher and 175° C. or lower and the anti-blocking agent. One or two or more different types of polypropylene resins may be used as the polypropylene resin having a melting point of 150° C. or higher and 175° C. or lower. The total amount of the polypropylene resin having a melting point of 150° C. or higher and 175° C. or lower and the anti-blocking agent is preferably from 90% by mass to 100% by mass, more preferably from 95% by mass to 100% by mass, and further preferably from 98% by mass to 100% by mass in the surface layer C. The polypropylene resin used in the surface layer C has a melting point of preferably from 154° C. to 170° C., and more preferably from 158° C. to 165° C.

The polypropylene resin having a melting point of 150° C. or higher and 175° C. or lower is preferably a polypropylene homopolymer (a polypropylene homopolymer entirely free from an α-olefin component other than propylene and/or a polypropylene copolymer containing 1 mol % or less of an α-olefin component other than propylene and 99 mol % or more of propylene as constituent units).

Hereinafter, preferred physical properties of the polypropylene resin having a melting point of 150° C. or higher and 175° C. or lower will be described. When two or more different types of the polypropylene resins having a melting point of 150° C. or higher and 175° C. or lower are used, mass-averages of the physical properties of each polypropylene resin are preferably within the numerical ranges described below.

The polypropylene resin having a melting point of 150° C. or higher and 175° C. or lower used in the surface layer C has a weight-average molecular weight (Mw) of preferably from 180,000 to 500,000. If the Mw is less than 180,000, the melt viscosity becomes low, casting may become unstable, and the film formability may deteriorate. If the Mw is more than 500,000, the amount of components having a molecular weight of 100,000 or less decreases, and the heat shrinkage rate at high temperature may decrease. The Mw is more preferably from 190,000 to 400,000, further preferably from 230,000 to 380,000, and particularly preferably from 270,000 to 350,000.

The polypropylene resin having a melting point of 150° C. or higher and 175° C. or lower used in the surface layer C has a number-average molecular weight (Mn) of preferably from 20,000 to 200,000. If the Mn is less than 20,000, the melt viscosity becomes low, casting may become unstable, and the film formability may deteriorate. If the Mn is more than 200,000, the heat shrinkage rate at high temperature may decrease. The Mn is more preferably from 30,000 to 80,000, further preferably from 40,000 to 70,000, and particularly preferably from 50,000 to 60,000.

The polypropylene resin having a melting point of 150° C. or higher and 175° C. or lower used in the surface layer C has an Mw/Mn, which is an indicator of molecular weight distribution, of preferably 2.8 or more and 10 or less, more preferably 3.2 or more and 8.0 or less, further preferably 3.5 or more and 7.0 or less, and particularly preferably 4.0 or more and 6.0 or less.

The surface layer C may contain an additive and a resin other than the polypropylene resin having a melting point of 150° C. or higher and 175° C. or lower. Examples of the additive include anti-blocking agents, antioxidants, ultraviolet absorbers, nucleating agents, adhesives, antifogging agents, flame retardants, and inorganic and organic fillers. From the viewpoint of imparting the slipperiness and the anti-blocking properties to the surface layer C, the surface layer C preferably contains an anti-blocking agent. Examples of the other resin include polyolefin resins other than the polypropylene resin having a melting point of 150° C. or higher and 175° C. or lower and various elastomers. These may be used by sequential polymerization using a multi-stage reactor, by blending with the polypropylene resin using a Henschel mixer, by diluting a previously prepared master pellet with polypropylene to predetermined concentrations using a melt kneader, or by melt-kneading a whole amount in advance. The amount of the polypropylene resin having a melting point of 150° C. or higher and 175° C. or lower is preferably from 80% by mass to 100% by mass, more preferably from 90% by mass to 100% by mass, further preferably from 95% by mass to 100% by mass, and particularly preferably from 98% by mass to 100% by mass based on the total resins contained in the surface layer C.

As the anti-blocking agent, particles having a pore volume of preferably from 0.2 mL/g to 3 mL/g, more preferably from 0.5 mL/g to 2.5 mL/g, and further preferably from 1.1 mL/g to 1.8 mL/g are used. The anti-blocking agent may be appropriately selected and used from inorganic and organic particles. Among them, the use of a silicon compound is particularly preferred. Examples of the silicon compound include silica, silicates, and compounds each having a main backbone formed by siloxane bonds. Among them, porous silica particles are particularly preferred. When porous silica particles are used, those having a pore volume of from 0.8 mL/g to 2 mL/g are preferred, and those having a pore volume of from 1.1 mL/g to 1.8 mL/g are more preferred. The anti-blocking agent used in the surface layer C is preferably the same as the anti-blocking agent used in the surface layer B.

The particle shape may be spherical or irregular, and irregular-shaped particles are preferably used. The particles have an average particle size of preferably 1 μm or more and 5 μm or less, and more preferably 2 μm or more and 4 μm or less. The average particle size is determined by capturing images with a scanning electron microscope, measuring the horizontal Feret's diameter using an image analysis device, and calculating the average.

The content of the anti-blocking agent is preferably 100 ppm or more and 10000 ppm or less, more preferably 300 ppm or more and 6000 ppm or less, further preferably 800 ppm or more and 4000 ppm or less, and particularly preferably 1500 ppm or more and 3000 ppm or less based on the total mass of the surface layer C. By adjusting the content within the above range, the three-dimensional average roughness and the Martens hardness of the surface layer C can be controlled within predetermined ranges described below. When the content is 100 ppm or more, the film exhibits high slipperiness and enhanced anti-blocking properties. When the content is 10000 ppm or less, it is less likely that excessive addition of the anti-blocking agent results in decreased optical transparency, penetration of the anti-blocking agent through the functional layer during lamination of the functional layer, and sparse formation of the functional layer in the vicinity of the surface layer B caused by the anti-blocking agent protruding from the surface layer C; hence, the degradation of barrier properties and poor adhesion are unlikely to occur. The content of the anti-blocking agent in the surface layer C preferably exceeds the content of the anti-blocking agent in the surface layer B.

When the surface layer C contains the anti-blocking agent, the fall-off rate of the anti-blocking agent in the surface layer C is preferably 10% or less, more preferably 8% or less, further preferably 6% or less, and particularly preferably 4% or less. When the fall-off rate is 10% or less, contamination of a guide roll during post-processing such as coating and vapor deposition can be suppressed. Furthermore, the occurrence of voids caused by the falling off of the anti-blocking agent can be suppressed, and high gas barrier properties can be achieved when metal and/or metal oxide is vapor-deposited. The lower limit of the fall-off rate is not particularly limited, and is, for example, 0.3% or more.

### (4) Layer Structure and Thicknesses of Biaxially Oriented Polypropylene Film

The biaxially oriented polypropylene film of the present invention has the surface layer B on one surface of the base layer A. The surface layer B may be laminated directly on the surface of the base layer A, or the surface layer B may be laminated on the base layer A via another layer. When the film has the surface layer C on the other surface of the base layer A, the surface layer C may be laminated directly on the surface of the base layer A, or the surface layer C may be laminated on the base layer A via another layer. For example, the biaxially oriented polypropylene film of the present invention may have a two-layer structure of only surface layer B/base layer A, a three-layer structure of only surface layer B/base layer A/surface layer C, or a multi-layer structure of four or more layers including a layer other than the base layer A, the surface layer B, and the surface layer C. Examples of the four-layer structure include “surface layer B/intermediate layer D/base layer A/surface layer C”, in which the inclusion of the intermediate layer D can further enhance the adhesion between the base layer A and the surface layer B.

The total thickness of the biaxially oriented polypropylene film of the present invention is preferably from 5 μm to 100 μm, more preferably from 10 μm to 80 μm, and further preferably from 18 μm to 50 μm. When the total thickness is within the above range, the film has sufficient stiffness, and the film is suitable as a base material for packaging and industrial applications.

The thickness of the surface layer B is preferably from 0.3 μm to 10 μm, more preferably from 0.5 μm to 3 μm, and further preferably from 0.8 μm to 2 μm. When the surface layer B has a thickness of 0.3 μm or more, the adhesion between the surface layer B and the functional layer can be enhanced, and the film is suitably used as a base material for packaging and industrial applications that require the formation of a functional layer through vapor deposition or coating process. When the thickness of the surface layer B is more than 10 μm, the thickness ratio of the base layer A may become relatively low, and the stiffness and the thermal dimensional stability of the film may be decreased as a result.

When the film includes the surface layer C, the thickness of the surface layer C is preferably from 0.3 μm to 10 μm, more preferably from 0.5 μm to 5 μm, and further preferably from 0.8 μm to 3 μm. When the thickness is 0.3 μm or more, the slipperiness and the processability of the film may be ensured. When the thickness of the surface layer C is more than 10 μm, the thickness ratio of the base layer A may become relatively low, and the stiffness and the thermal dimensional stability of the film may be decreased as a result.

The thickness of the base layer A is preferably from 5 μm to 90 μm, more preferably from 10 μm to 50 μm, and further preferably from 15 μm to 30 μm. When the thickness of the base layer A is 5 μm or more, the thermal dimensional stability and the mechanical strength of the film can be enhanced. Although the thermal dimensional stability and the mechanical strength can be enhanced when the base layer A has a thickness of more than 90 μm, these effects may be saturated.

The biaxially oriented polypropylene film of the present invention can be obtained by melt extruding the polypropylene resin compositions, each of which constitutes the base layer A, the surface layer B, and the like, from separate extruders, co-extruding them from a T-die, cooling them with a cooling roll to obtain an unstretched sheet, stretching the unstretched sheet in the longitudinal direction (MD) and the width direction (TD), and heat-setting the resulting biaxially stretched film.

The melt extrusion temperature is preferably from 200° C. to 280° C. Within this predetermined temperature range, in order to obtain a film with excellent appearance through co-extrusion of the layers A and B without disrupting the layers, the difference in MFRs between the base layer A and the surface layer B (hereinafter referred to as “MER difference”) is preferably adjusted to 5.0 g/10 min or less. If the MFR difference is more than 5.0 g/10 min, layer disruption may occur, which results in appearance defects. The MFR difference is more preferably 4.0 g/10 min or less, and further preferably 3.0 g/10 min or less. When the film includes the surface layer C, the difference between the maximum MFR and the minimum MFR among the three polypropylene resin compositions constituting the base layer A, the surface layer B, and the surface layer Cis preferably adjusted to 5.0 g/10 min or less, and more preferably to 3.0 g/10 min or less.

The surface temperature of the cooling roll is preferably from 25° C. to 50° C., and more preferably from 30° C. to 45° C. When the cooling roll temperature is 50° C. or lower, the crystallization of the unstretched sheet and the growth of spherulites can be prevented, hence, a higher stretching ratio can be achieved, which results in a film with high tensile modulus. Furthermore, the formation of large surface irregularities caused by the spherulites can be prevented, and a film with appropriate surface roughness can be obtained.

The lower limit of the stretching ratio in the longitudinal direction (MD) is preferably 3.5 times or more, and more preferably 4 times or more. When the stretching ratio is 3.5 times or more, thickness variation tends to be reduced. The upper limit of the MD stretching ratio is preferably 8 times or less, and more preferably 7 times or less. When the stretching ratio is 8 times or less, breakage is less likely to occur in subsequent TD stretching, and production is easier.

The lower limit of the MD stretching temperature is preferably 120° C. or higher, more preferably 130° C. or higher, and further preferably 135° C. or higher. When the MD stretching temperature is 120° C. or higher, an increase in the thickness irregularities may be prevented, and the surface roughening of the film may be prevented. A higher MD stretching temperature may prevent the formation of voids around the anti-blocking agent particles, and thus may prevent roll contamination during processing caused by the fall-off of the anti-blocking agent particles at the film surface. Furthermore, high gas barrier properties can be achieved when aluminum is vapor-deposited.

The upper limit of the MD stretching temperature is preferably 150° C. or lower, more preferably 145° C. or lower, and further preferably 140° C. or lower. When the MD stretching temperature is excessively high, the film may begin to adhere to the MD stretching roll and cause stick-slip, which may result in film irregularities and surface roughening. Further increases in the MD stretching temperature may lead to adhesion of the film to the stretching roll, which may prevent stretching.

The lower limit of the stretching ratio in the width direction (TD) is preferably 6 times or more, more preferably 7 times or more, and further preferably 8 times or more. When the stretching ratio is 6 times or more, thickness variation tends to be reduced. The upper limit of the TD stretching ratio is preferably 15 times or less, more preferably 13 times or less, and further preferably 11 times or less. A stretching ratio more than the above range may lead to increases in the heat shrinkage rate and thus breakage during stretching.

When the mesopentad fraction of the polypropylene homopolymer constituting the base layer A is not high, the preheating temperature in the TD stretching is preferably set to be from 1° C. to 5° C. higher than the stretching temperature. When the mesopentad fraction of the polypropylene homopolymer constituting the base layer A is high, the preheating temperature in the TD stretching is preferably set to from 7° C. to 20° C. higher than the stretching temperature, in order to rapidly raise the temperature from the preheating temperature to near the stretching temperature in the TD stretching. The lower limit of the TD stretching temperature is preferably 150° C. or higher, more preferably 152° C. or higher, further preferably 154° C. or higher, and particularly preferably 156° C. or higher. A TD stretching temperature of 150° C. or higher allows for sufficient softening of the film, and film breakage and an increase in the heat shrinkage rate may be prevented. The upper limit of the TD stretching temperature is preferably 170° C. or lower, more preferably 168° C. or lower, and further preferably 166° C. or lower.

A higher heat-setting temperature is preferred to reduce the heat shrinkage rate, and the heat-setting temperature is more preferably 160° C. or higher, further preferably 162° C. or higher. A heat-setting temperature of 160° C. or higher can suppress an increase in the heat shrinkage rate, and long-time treatment for reducing the heat shrinkage rate is not required. The upper limit of the heat-setting temperature is preferably 180° C. or lower, and more preferably 175° C. or lower. When the heat-setting temperature is 180° C. or lower, melting of low-molecular-weight components and reduction in orientation due to recrystallization are unlikely to occur, and surface roughening and film whitening may also be suppressed.

It is preferable to relax the film during heat-setting. The lower limit of the relaxation rate is preferably 2% or more, more preferably 3% or more, and further preferably 5% or more. A relaxation rate of 2% or more may suppress an increase in the heat shrinkage rate. The upper limit of the heat shrinkage rate is preferably 10% or less, and more preferably 8% or less. A heat shrinkage rate of 10% or less may suppress an increase in thickness unevenness.

In order to further reduce the heat shrinkage rate, the film may be annealed off-line after the film produced through the above process was wound into a roll.

The film thus obtained is then subjected to, if needed, corona discharge treatment, plasma treatment, or flame treatment, and wound using a winder to obtain the biaxially oriented polypropylene film roll of the present invention.

The method for producing the biaxially oriented polypropylene film of the present invention is not limited to the production method described above.

### (5) Characteristics of Biaxially Oriented Polypropylene Film of the Present Invention

### (Haze)

The biaxially oriented polypropylene film of the present invention has a haze of preferably 8% or less, more preferably 5% or less, further preferably 4% or less, and particularly preferably 3% or less. The haze within the above range makes it easier to use the film in applications requiring transparency. Haze tends to deteriorate when the stretching temperature is excessively high; when the heat-setting temperature is excessively high; when the cooling speed of the unstretched (raw) sheet is low due to a high cooling roll temperature; or when the content of the low-molecular-weight component having a molecular weight of 100,000 or less is excessive. The haze can be controlled within the range by adjusting these conditions.

### (Tensile Modulus)

The biaxially oriented polypropylene film of the present invention preferably has a tensile modulus in the longitudinal direction of preferably 1.0 GPa or more, more preferably 1.5 GPa or more, further preferably 1.8 GPa or more, and particularly preferably 2.0 GPa or more. The upper limit is not particularly limited, and is, for example, 5.0 GPa or less.

The biaxially oriented polypropylene film of the present invention preferably has a tensile modulus in the width direction of preferably 3.0 GPa or more, more preferably 3.2 GPa or more, and further preferably 3.5 GPa or more. The upper limit is not particularly limited, and is, for example, 10 GPa or less.

The sum of the tensile moduli in the longitudinal direction and the width direction of the biaxially oriented polypropylene film of the present invention is preferably from 5.8 Pa to 12.0 Pa, and more preferably from 6.0 GPa to 10.0 GPa.

When the tensile moduli are within the above range, the film can exhibit enhanced stiffness, and the film with reduced thickness becomes available, which results in cost reduction.

In the present invention, “the longitudinal direction” of the biaxially oriented polypropylene film refers to the flow direction in the film production process, and “the width direction” refers to a direction perpendicular to the flow direction in the film production process. The same definitions shall apply hereinafter.

### (Heat Shrinkage Rate)

The biaxially oriented polypropylene film of the present invention has a heat shrinkage rate at 150° C. in the longitudinal direction of preferably 15.0% or less, more preferably 9.0% or less, further preferably 7.0% or less, and particularly preferably 5.0% or less. The lower limit of the heat shrinkage rate at 150° C. in the longitudinal direction is preferably 0% or more. A heat shrinkage rate within the above range allows the use of the film in applications where the film may be exposed to high temperatures. Furthermore, if the functional layer is laminated on the film, a decrease in the barrier properties of the functional layer can be prevented, and the barrier properties of the laminated body can be enhanced as a result.

The biaxially oriented polypropylene film of the present invention has a heat shrinkage rate at 150° C. in the width direction of preferably 20.0% or less, more preferably 10.0% or less, and further preferably 8.0% or less. The lower limit of the heat shrinkage rate at 150° C. in the width direction is preferably 0% or more. A heat shrinkage rate within the above range allows the use of the film in applications where the film may be exposed to high temperatures. Furthermore, if the functional layer is laminated on the film, a decrease in the barrier properties of the functional layer can be prevented, and the barrier properties of the laminated body can be enhanced as a result.

The sum of the heat shrinkage rates at 150° C. in the longitudinal direction and the width direction of the biaxially oriented polypropylene film of the present invention is 25.0% or less, preferably 23.0% or less, more preferably 20.0% or less, further preferably 15.0% or less, and particularly preferably 12.0% or less. The lower limit of the sum of the heat shrinkage rates at 150° C. in the longitudinal direction and the width direction is 0% or more. The sum of the heat shrinkage rates within the above range allows the use of the film in applications where the film may be exposed to high temperatures. Furthermore, if the functional layer is laminated on the film, a decrease in the barrier properties of the functional layer can be prevented, and the barrier properties of the laminated body can be enhanced as a result.

### (Wetting Tension)

The wetting tension on the surface of the surface layer B of the biaxially oriented polypropylene film of the present invention is 36 mN/m or more, preferably 38 mN/m or more, and more preferably 40 mN/m or more. The wetting tension of 36 mN/m or more improves the adhesion to the functional layer. The wetting tension is adjusted to 36 mN/m or more by preferably conducting physicochemical surface treatments such as corona treatment and flame treatment. In corona treatment, it is preferable to perform discharge in air using a preheating roll and a treatment roll. Since excessively high wetting tension may impair the slipperiness and the anti-blocking properties, the wetting tension is preferably 46 mN/m or less.

When another material is further laminated on the surface layer C, the wetting tension on the surface of the surface layer C of the biaxially oriented polypropylene film of the present invention is preferably 36 mN/m or more, more preferably 38 mN/m or more, and further preferably 40 mN/m or more, similarly to the surface layer B. Since excessively high wetting tension may impair the slipperiness and the anti-blocking properties, the wetting tension is preferably 46 mN/m or less. If another material is not laminated on surface of the surface layer C, the wetting tension is preferably 32 mN/m or less from the viewpoint of the slipperiness and the anti-blocking properties.

### (Surface Resistance Value)

The surface resistance value of the surface layer B of the biaxially oriented polypropylene film of the present invention is preferably 14 Log Ω or more, more preferably 14.5 Log Ω or more, and further preferably 15 Log Ω or more. If the film contains an additive such as an antistatic agent and impurities, the surface resistance value may fall below 14 Log Ω, and the adhesion may be impaired. A surface resistance value of 14 Log Ω or more is preferred from the viewpoint of the adhesion to the functional layer. A preferred upper limit of the surface resistance value of the surface layer B is not particularly limited, and is 18 Log Ω or less from the viewpoint of the film production.

The surface resistance value of the surface layer C of the biaxially oriented polypropylene film of the present invention is preferably 14 Log (or more, more preferably 14.5 Log Ω or more, and further preferably 15 Log Ω or more. If the film contains an additive such as an antistatic agent and impurities, the surface resistance value may fall below 14 Log Ω, and the adhesion may be impaired. A surface resistance value of 14 Log Ω or more is preferred from the viewpoint of the adhesion to the functional layer. A preferred upper limit of the surface resistance value of the surface layer C is not particularly limited, and is 18 Log Ω or less from the viewpoint of the film production.

### (Martens Hardness)

The Martens hardness of the surface layer B of the biaxially oriented polypropylene film of the present invention is 248 N/mm² or less, preferably 245 N/mm² or less, more preferably 230 N/mm² or less, and further preferably 210 N/mm² or less.

The Martens hardness of the surface layer B of 248 N/mm² or less improves the adhesion between the surface layer B and the functional layer. Also, the adhesion is readily improved by reducing the thickness ratio of the surface layer B to the total thickness of the film. The Martens hardness is easily adjusted to 248 N/mm² or less by using the polypropylene resin composition containing 25% by mass or more and 85% by mass or less of the polypropylene resin having a melting point of 130° C. or higher and 158° C. or lower in the surface layer B. The Martens hardness can also be decreased by modifying film formation conditions to suppress orientation crystallization of molecular chains, for example, by lowering the film stretching ratio. The lower limit of the Martens hardness of the surface layer B is preferably 150 N/mm² or more, and more preferably 165 N/mm² or more.

The Martens hardness of the surface layer C of the biaxially oriented polypropylene film of the present invention is preferably 250 N/mm² or more, more preferably 260 N/mm² or more, and further preferably 270 N/mm² or more. The upper limit of the Martens hardness of the surface layer C is preferably 350 N/mm² or less, and more preferably 300 N/mm² or less.

The Martens hardness of the surface layer B indicates the hardness of the surface layer B measured using a dynamic ultra micro hardness tester under conditions described in the EXAMPLES below. The Martens hardness of the surface layer C is measured in the same manner.

### (Three-Dimensional Average Roughness)

The biaxially oriented polypropylene film of the present invention has the three-dimensional average roughness SRa of the surface layer B of preferably 10 nm or more and 100 nm or less, more preferably 13 nm or more and 90 nm or less, further preferably 15 nm or more and 80 nm or less, particularly preferably 17 nm or more and 70 om or less, and most preferably 19 nm or more and 50 nm or less. When the three-dimensional average roughness of the surface layer B is 10 nm or more, the film exhibits high slipperiness, and wrinkling during winding into a roll and post-processing such as a vapor deposition process can be prevented. When the three-dimensional average roughness is 100 nm or less, the film exhibits high transparency, and deterioration in workability, caused when the film is significantly slippery, can be prevented during winding into a roll and post-processing such as vapor deposition.

The three-dimensional average roughness SRa of the surface layer C of the biaxially oriented polypropylene film of the present invention is preferably 15 nm or more and 100 nm or less, more preferably 20 nm or more and 70 nm or less, and further preferably 30 nm or more and 50 nm or less. When the three-dimensional average roughness of the surface layer Cis 15 nm or more, the film exhibits high slipperiness, and wrinkling during winding into a roll and post-processing such as a vapor deposition process can be prevented. When the three-dimensional average roughness is 100 nm or less, the film exhibits high transparency, and deterioration in workability, caused when the film is significantly slippery, can be prevented during winding into a roll and post-processing such as vapor deposition.

### (6) Laminated Body Further Including Functional Layer

The application of the biaxially oriented polypropylene film of the present invention is not limited to packaging and can also be used for industrial purposes. In order to improve the gas barrier properties and the design characteristics of the biaxially oriented polypropylene film of the present invention, the film may be formed into a laminated body provided with a functional layer such as a vapor-deposited layer, a coating layer, or a printing layer.

As materials for the vapor-deposited layer, metal and/or metal oxide is preferred, aluminum, Al₂O₃, SiO_{λ} (X<2), a mixture of Al₂O₃ and SiO₂, or a mixture of Al and SiO₂ is more preferred, and aluminum, or a mixture of Al and SiO₂ is further preferred. The thickness of the vapor-deposited layer is preferably from 5 nm to 40 nm, and more preferably from 10 nm to 30 nm.

In order to enhance the gas barrier properties, the vapor-deposited layer and/or the coating layer is preferably laminated on the biaxially oriented polypropylene film of the present invention.

A method for forming the vapor-deposited layer is not particularly limited as long as known production methods such as PVD methods (physical vapor deposition methods) including a vacuum vapor deposition method, a sputtering method, and an ion plating method, and a CVD method (chemical vapor deposition method) are employed. Among them, a physical vapor deposition method is preferred, and a vacuum vapor deposition method is more preferred. For example, in the vacuum vapor deposition method, aluminum, Al₂O₃, SiOₓ (X<2), a mixture of Al₂O₃ and SiO₂, and a mixture of Al and SiO₂ can be used as materials for vapor deposition, and known heating methods such as resistive heating, high frequency induction heating, and electron beam heating can be employed. Furthermore, reaction gases such as oxygen, nitrogen, and water vapor may be introduced, and reactive deposition using ozone addition or ion-assisted deposition may be employed. Conditions for forming the vapor-deposited layer may be changed as long as the object of the present invention is not impaired, for example, by biasing the biaxially oriented polypropylene film of the present invention, or by lowering or raising the temperature of the biaxially oriented polypropylene film of the present invention. The same applies to other production methods such as sputtering and CVD.

When improvement in the barrier properties is required, polyvinylidene chloride, nylon, butanediol-vinyl alcohol copolymer, ethylene-vinyl alcohol copolymer, and polyvinyl alcohol may be used as materials for the coating layer. The amount of the coating of the coating layer after drying is preferably from 0.03 g/m² to 3 g/m², and more preferably from 0.1 g/m² to 0.3 g/m².

When a vapor-deposited layer is provided, the upper limit of the oxygen transmission rate at 23° C. and 65% relative humidity of the vapor-deposited film is preferably 50 mL/m²/day/MPa, more preferably 39 mL/m²/day/MPa, further preferably 30 mL/m²/day/MPa, and particularly preferably 25 mL/m²/day/MPa. When the upper limit of the oxygen transmission rate is 50 mL/m²/day/MPa, the film exhibits excellent preservation performance for substances that deteriorate due to oxygen and foodstuffs. The lower limit of the oxygen transmission rate at 23° C. and 65% relative humidity of the vapor-deposited film is not particularly limited, and is preferably 0.1 mL/m²/day/MPa from the viewpoint of productivity.

### (7) Heat Sealable Laminated Body

In application for packaging, the biaxially oriented polypropylene film of the present invention, or a laminated body obtained by providing the vapor-deposited layer and/or the coating layer on the film may be laminated with a heat-sealable film to form a heat sealable laminated body, and the heat sealable laminated body may be then processed into a packaging bag. Examples of the heat-sealable film include unstretched films, uniaxially stretched films, and biaxially stretched films formed from low-density polyethylene, linear low-density polyethylene, ethylene-vinyl acetate copolymer, polypropylene, and/or polyester. In particular, unstretched films or uniaxially stretched films formed from any one type from low-density polyethylene, linear low-density polyethylene, and polypropylene are preferred.

The heat-sealable film may be laminated on either the surface layer B side, or the opposite side to the surface layer B side. The heat-sealable film is preferably laminated via an adhesive layer. Examples of the adhesive include ester-based adhesives, urethane-based adhesives, acrylic-based adhesives, and polyethyleneimine-based adhesives. The film may be laminated by lamination methods such as a dry lamination method, an extrusion lamination method, and a co-extrusion method.

The packaging bag obtained by processing the heat sealable laminated body, formed by laminating a heat-sealable film on the biaxially oriented polypropylene film of the present invention or the laminated body in which the vapor-deposited layer and/or the coating layer is formed on the biaxially oriented polypropylene film, can be used as a packaging container with excellent suitability for filling and packaging and excellent suitability for preservation, for various contents such as food and beverages, pharmaceuticals, detergents, shampoos, oils, toothpaste, adhesives, and tackiness agents.

Examples of the layer structure of the heat sealable laminated body of the present invention include, with each layer boundary indicated by “/”, OPP/adhesive/LLDPE, OPP/adhesive/CPP, OPP/adhesive/Al/adhesive/CPP, OPP/adhesive/Al/adhesive/LLDPE, OPP/PE/Al/adhesive/LLDPE, OPP/adhesive/Al/PE/LLDPE, PET/adhesive/OPP/adhesive/LLDPE, PET/adhesive/OPP/PE/LLDPE, PET/adhesive/OPP/adhesive/Al/adhesive/LLDPE, PET/adhesive/Al/adhesive/OPP/adhesive/LLDPE, PET/adhesive/Al/adhesive/OPP/PE/LLDPE, PET/PE/Al/PE/OPP/PE/LLDPE, PET/adhesive/OPP/adhesive/CPP, PET/adhesive/OPP/adhesive/Al/adhesive/CPP, PET/adhesive/Al/adhesive/OPP/adhesive/CPP, OPP/adhesive/PET/adhesive/LLDPE, OPP/adhesive/PET/PE/LLDPE, OPP/adhesive/PET/adhesive/CPP, OPP//Al//PET//LLDPE, OPP/adhesive/Al/adhesive/PET/PE/LLDPE, OPP/PE/LLDPE, OPP/PE/CPP, OPP/PE/Al/PE, OPP/PE/Al/PE/LLDPE, OPP/adhesive/OPP/adhesive/LLDPE, OPP/adhesive/conventional OPP/adhesive/LLDPE, OPP/adhesive/EVOH/adhesive/LLDPE, OPP/adhesive/EVOH/adhesive/CPP, OPP/adhesive/aluminum- or inorganic oxide-vapor-deposited OPP/adhesive/LLDPE, conventional OPP/adhesive/aluminum- or inorganic oxide-vapor-deposited OPP/adhesive/LLDPE, OPP/adhesive/aluminum- or inorganic oxide-vapor-deposited OPP/adhesive/LLDPE, OPP/adhesive/aluminum- or inorganic oxide-vapor-deposited PET/adhesive/LLDPE, OPP/adhesive/aluminum vapor-deposited OPP/adhesive/OPP/adhesive/LLDPE, OPP/adhesive/aluminum vapor-deposited PET/adhesive/OPP/adhesive/LLDPE, OPP/adhesive/aluminum vapor-deposited OPP/PE/LLDPE, OPP/adhesive/aluminum vapor-deposited PET/PE/LLDPE, OPP/PE/aluminum vapor-deposited OPP/PE/LLDPE, OPP/PE/aluminum vapor-deposited PET/PE/LLDPE, OPP/adhesive/aluminum vapor-deposited OPP/adhesive/CPP, OPP/adhesive/aluminum vapor-deposited PET/adhesive/CPP, PET/adhesive/aluminum vapor-deposited PET/adhesive/OPP/adhesive/LLDPE, CPP/adhesive/OPP/adhesive/LLDPE, OPP/adhesive/aluminum vapor-deposited LLDPE, and OPP/adhesive/aluminum vapor-deposited CPP.

The abbreviations used for each layer in the above structures are as follows: “aluminum vapor-deposited” indicates that aluminum is vapor-deposited on the film; “inorganic oxide-vapor-deposited” indicates that an inorganic oxide is vapor-deposited on the film, “aluminum- or inorganic oxide-vapor-deposited” indicates that aluminum or an inorganic oxide is vapor-deposited on the film.
OPP: Biaxially oriented polypropylene film of the present invention
PET: Stretched polyethylene terephthalate film
LLDPE: Unstretched linear low-density polyethylene film
PE: Polyethylene film other than LLDPE
CPP: Unstretched polypropylene film
Conventional OPP: Conventional stretched polypropylene film commercially available on the market
Al: Aluminum foil
EVOH: Ethylene-vinyl alcohol copolymer resin film
Adhesive: Adhesive layer to adhere films

The present application claims benefit of priority to Japanese Patent Application No. 2023-012346 filed on Jan. 30, 2023. The entire contents of the specification of Japanese Patent Application No. 2023-012346 filed on Jan. 30, 2023, are incorporated herein by reference.

### EXAMPLES

Hereinafter, the present invention will be described with Examples, and the scope of the present invention is not limited thereto.

### (Measurement Method)

The physical properties of raw materials used and films obtained in Examples and Comparative Examples were measured according to the following methods. The physical properties of the polypropylene resins used in each layer were measured in the following 1) to 4), the physical properties of the biaxially oriented polypropylene films were measured in the following 5) to 17), and the physical properties of the laminated bodies, each including the biaxially oriented polypropylene film and another layer such as a functional layer laminated on the film, were measured in the following 18) to 21).

### 1) Melting Point

The melting point was determined as the main peak temperature of an endothermic peak associated with melting, as obtained using a differential scanning calorimeter (DSC, manufactured by Seiko Instruments Inc.), when 10 mg of a sample placed in an aluminum sample pan and set in the instrument was, under a nitrogen atmosphere, melted at 230° C. for 5 minutes, then cooled to 30° C. at a scanning rate of ~10° C./min and held for 5 minutes, and subsequently heated at a scanning rate of 10° C./min.

2) Mesopentad Fraction (mmmm)

The mesopentad fraction was determined through ¹³C-NMR measurement. The mesopentad fraction was calculated in accordance with the method described in Zambelli, et al., “Macromolecules”. vol. 6, page 925 (1973). The RC-NMR measurement was performed at 110° C. using “AVANCE500” manufactured by Bruker Corporation, with 200 mg of the sample dissolved in an 8:2 (volume ratio) mixed solution of o-dichlorobenzene and deuterated benzene at 135° C.

### 3) Melt Flow Rate (MFR)

The measurement was performed at 230° C. under a load of 2.16 kgf in accordance with JIS K 7210.

### 4) Number-Average Molecular Weight (Mn), Weight-Average Molecular Weight (Mw), and Molecular Weight Distribution (Mw/Mn)

The molecular weight and the molecular weight distribution of the polypropylene resin were determined by gel permeation chromatography (GPC), based on monodisperse polystyrene. The measurement conditions by GPC, including the column and solvent used, were as follows.
Solvent: 1,2,4-trichlorobenzene
Column: TSKgel GMHHR-H (20) HT×3
Flow rate: 1.0 ml/min
Detector: RI
Measurement temperature: 140° C.

Each of the number-average molecular weight (Mn), the weight-average molecular weight (Mw), and the molecular weight distribution (Mw/Mn) were defined by the following equation, based on the number (Ni) of molecules corresponding to each molecular weight (Mi) at the respective eluted position on a GPC curve obtained by using a molecular weight calibration curve.
Number-average molecular weight: Mn=Σ(Nᵢ·Mᵢ)/ΣNᵢ
Weight-average molecular weight: Mw==Σ(Nᵢ·Mᵢ²)/Σ(Nᵢ·Mᵢ)
Molecular weight distribution: Mw/Mn

When the base line was not clearly defined, a base line was set within the range extending to the lowest point on the high-molecular-weight side of the elution peak closest to the standard substance elution peak.

### 5) Thickness

The film embedded in a modified urethane resin was cut into cross-sections with a microtome. The thickness of each layer was measured by subsequently observing the section using a differential interference contrast microscope.

### 6) Haze

The haze of the film was measured at 23° C. using a haze meter (300A, manufactured by NIPPON DENSHOKU INDUSTRIES CO., LTD.) in accordance with JIS K 7105. The measurement was repeated twice, and the average was calculated.

### 7) Appearance

The appearance of the film was visually evaluated under illumination with a brom light (VIDEO LIGHT VLG301 100V 300W manufactured by LPL Co., Ltd.) at an angle of approximately 45° to the film surface in accordance with the following criteria.

A: No irregularities that would cause problems in product appearance were observed.

B: A large number of transparency irregularities caused by stick-slip on the longitudinal stretching roll were observed.

C: A significant number of transparency irregularities caused by stick-slip on the longitudinal stretching roll were observed, to an extent that the film was unacceptable as a commercial product.

### 8) Tensile Modulus

A test piece having dimensions of 10 mm along the film width direction and 180 mm along the film longitudinal direction was cut from the film using a razor. The measurement was performed in accordance with JIS K 7127 to determine the tensile modulus in the longitudinal direction, under conditions of a distance between chucks of 100 mm and a tensile speed of 200 mm/min in an atmosphere at 23° C. and 65% relative humidity, after the film had been allowed to stand for 12 hours in an atmosphere at 23° C. and 65% relative humidity. An average of five measurement results was calculated to determine the tensile modulus in the longitudinal direction. The measurement device used was Autograph AG5000A manufactured by Shimadzu Corporation.

Also, a test piece having dimensions of 180 mm along the film width direction and 10 mm along the film longitudinal direction was cut from the film using a razor, and the tensile modulus in the width direction was determined in the same manner as that for the measurement of the tensile modulus in the longitudinal direction.

### 9) Heat Shrinkage Rate

The measurement was conducted in accordance with JIS Z 1712 by the following method. The film was cut along the longitudinal direction and the width direction to prepare a test piece having dimensions of 20 mm in width and 200 mm in length. The test piece was then hung in a hot air oven at 150° C. and dried for five minutes. After heating, the film length was measured, and the heat shrinkage rate was determined as the rate of film shrinkage length relative to the original length.

10) Wetting Tension (mN/m)

The wetting tension of the surface layer B and the surface layer C was measured in accordance with JIS K 6768:1999, after the film was aged at 23° C. and 50% relative humidity for 24 hours.

### 11) Surface Resistance Value

The surface resistance value of the surface layer B and the surface layer C was measured in accordance with JIS K 6911:1995, after the film was aged at 23° C. and 65% relative humidity for 24 hours.

### 12) Martens Hardness

The obtained film was cut into a square sample of approximately 2 cm on each side, and the surface opposite the measurement surface was affixed onto a glass plate approximately 1 mm thick using an adhesive. Subsequently, the test piece was moisture conditioned by standing it for 12 hours in an atmosphere at 23° C. and 50% relative humidity. The Martens hardness of the surface layer B and the surface layer C of the test piece was measured using a dynamic ultra micro hardness tester (DUH-211, manufactured by Shimadzu Corporation) in accordance with a method described in ISO 14577-1:2002 under the following measurement conditions. The measurement was repeated at 10 different positions on the film, and the average of eight values, excluding the maximum and the minimum values, was calculated.

### <Measurement Conditions>

### (Setting)

Measurement environment: A temperature of 23° C. and 50% relative humidity
Test mode: Load-unload test
Indenter used: Dihedral angle of 115 degrees, a triangular pyramid indenter
Elastic modulus of indenter: 1.140×106 N/mm²
Poisson's ratio of indenter: 0.07
Cf-Ap, As correction: Yes

### (Conditions)

Test force: 0.10 mN
Load speed: 0.0050 mN/see
Load holding time: 5 seconds
Unload holding time: 0 seconds

### 13) Three-Dimensional Average Roughness SRa

The average roughness SRa of the surface layer B and the surface layer C was measured by a stylus method with a contact-type three-dimensional surface roughness meter (model: ET-4000A, manufactured by Kosaka Laboratory Ltd.) under the following conditions.
Stylus tip radius: 0.5 μm
Stylus force: 50 μN
A cut-off value: 800 μm
Measurement length: 500 μm
Measurement speed: 0.1 μm/sec
Sampling interval: 5 μm

### 14) Fall-Off Rate of Anti-Blocking Agent

A 0.5 kg weight with a velveteen fabric attached (contact area: 63 mm×63 mm) was placed in contact with a film measurement surface, and a friction test was conducted using a universal tensile tester (STM-T-50BP, manufactured by Toyo Baldwin Co., Ltd.) under the following conditions.
Temperature: 23° C.
Relative humidity: 50%
Number of friction operations: 5 consecutive friction operations on the evaluation area
Tensile speed: 200 mm/min

After the above treatment, observation was conducted at a magnification of 600× using a tabletop microscope (TM3030Plus Miniscope, manufactured by Hitachi High-Tech Corporation), and the total number of the anti-blocking agent observed and the number of the anti-blocking agent that had fallen off from the film were counted. The fall-off rate of the anti-blocking agent was calculated in accordance with the following equation.

Fall-off rate of anti-blocking agent (%)=(the number of anti-blocking agent that had fallen off from film)/(sum of the number of anti-blocking agent observed and the number of anti-blocking agent that had fallen off from film)×100

### 15) Dynamic Coefficient of Friction

Two films were prepared and overlapped so that the surface layer B of one film would face the surface layer C of the other film. The measurement was performed in an atmosphere at 23° C. and 50% relative humidity using a universal testing machine STM-T-50BP (manufactured by TOYO BALDWIN CO., Ltd.), in accordance with JIS K 7125:1999.

### 16) Contamination on Guide Roll

After a 500-meter-long film was passed through a slitter (NS-SLITTER FN-105, manufactured by NISHIMURA MFG. CO., LTD.), contamination on the guide roll was evaluated. An evaluation result of “A” was considered acceptable.

A: No contamination was observed on the guide roll.

B: Slight contamination was partially observed on the guide roll.

C: Contamination was observed over the entire surface of the guide roll.

### 17) Wrinkling in Film Roll

The produced biaxially oriented polypropylene film was cut to a width of 600 mm using a slitter and wound into a film roll with a winding length of 1500 m. Subsequently, wrinkling on the surface layer of the film roll was visually evaluated in accordance with the following criteria. An evaluation result of “A” was considered acceptable.

A+: No wrinkling was observed.

A: Slight wrinkling was observed, but it disappeared when a tension of approximately 5 N/m was applied to the unwound film.

B: Slight wrinkling was observed, but it disappeared when a tension of approximately 20 N/m was applied to the unwound film.

C: Prominent wrinkling was observed, and it did not disappear even when a tension of approximately 20 N/m was applied to the unwound film.

### 18) Coatability

A coating liquid having a solid content of 5% was prepared by dissolving butanediol-vinyl alcohol copolymer (Nichigo G-Polymer (registered trademark) OKS-8049Q, manufactured by Mitsubishi Chemical Corporation) in a 15% aqueous solution of isopropyl alcohol. Subsequently, films were taken from the film roll obtained by the production method described in item 17) above. The prepared coating liquid was dropped onto the surface layer B and the surface layer C of the films prepared, and the surfaces were coated using a Mayer bar #3 to achieve a coating amount of 0.2 g/m² on a solid basis. The coated films were then dried using a dryer to sufficiently evaporate the solution, and the repelling of the coating layer was visually evaluated. The film was considered “acceptable” when the visual evaluation result of the coating layer on the surface layer B was “A” or higher. In the case where a functional layer was further provided on the surface layer C, it was preferable that visual evaluation results of the coating layers on both the surface layer B and the surface layer C were “A” or higher.

A+: No repelling of the coating layer was observed.

A: Repelling was not observed in approximately 90% of the coating layer, but very slight repelling was observed.

B: Partial repelling of the coating layer was observed, and the area without repelling was less than 90%.

C: Repelling was observed throughout the entire coating layer.

### 19) Adhesion to Aluminum Vapor-Deposited Layer

A film was taken from the film roll obtained by the production method described in item 17) above. Subsequently, vapor deposition was carried out on the surface layer B of the unwound film, using a small-sized vacuum vapor deposition device (VWR-400/ERH, manufactured by ULVAC KIKO, Inc.), so that the thickness of the deposited layer would become 30 nm, and a vapor-deposited film provided with an aluminum vapor-deposited layer on the surface layer B was obtained. Then, a piece of cellophane tape (registered trademark) with a width of 18 mm manufactured by NICHIBAN CO., LTD. was applied to the aluminum vapor-deposited layer of the vapor-deposited film, and the adhesion to the aluminum vapor-deposited layer was evaluated by a 90-degree peel test. Evaluation result of “A” was considered acceptable.

A: No peeling of the aluminum vapor-deposited layer was observed.

B: Peeling of the aluminum vapor-deposited layer was partially observed.

C: Peeling of the aluminum vapor-deposited layer was observed over the entire surface.

### 20) Oxygen Transmission Rate of Aluminum Vapor-Deposited Film

The oxygen transmission rate of the vapor-deposited film produced by the production method described in item 19) above was measured in an environment at 23° C. and 65% relative humidity using an oxygen permeation testing analyzer (OX-TRAN 2/20, manufactured by METEK MOCON) in accordance with the electrolytic sensor method (Annex A) described in JIS K 7126-2. The measurement of oxygen transmission rate was conducted in the direction in which oxygen permeates from the base layer A side to the aluminum vapor-deposited layer.

### 21) Laminate Strength

The laminate strength was measured according to the following procedure.

### Procedure 1) Production of Laminated Body Including Biaxially Oriented Polypropylene Film and Unstretched Polyethylene Film

The laminated body was prepared using a continuous type dry-laminator as follows.

An adhesive was applied by gravure coating to the surface of the surface layer B side of each of the biaxially oriented polypropylene films obtained in Examples and Comparative Examples, so that the application amount after drying would become 2.8 g/m². The coated film was then introduced into a drying zone and dried at 80° C. for five seconds. Subsequently, the film was laminated with a sealant film between downstream rolls (roll pressure: 0.2 MPa, roll temperature: 50° C.). The resulting laminated film was aged at 40° C. for three days in a wound state.

The adhesive used was a urethane-based adhesive prepared by mixing 28.9% by mass of a main agent (TM569 manufactured by Toyo-Morton, Ltd.), 4.00% by mass of a curing agent (CAT10L manufactured by Toyo-Morton, Ltd.), and 67.1% by mass of ethyl acetate. As the sealant film, an unstretched polyethylene film (LIX (registered trademark) L4102, thickness: 40 μm) manufactured by TOYOBO Co., Ltd. was used.

### Procedure 2) Measurement of Laminate Strength

A strip was taken from the laminated film produced above, with a length of 200 mm along the long side, i.e., the longitudinal direction, of the biaxially oriented polypropylene film, and a width of 15 mm. Subsequently, the peel strength was measured by peeling the strip apart in a T-peel configuration at a tensile speed of 200 mm/min using a tensile tester (Tensilon, manufactured by ORIENTEC CORPORATION) in an environment at 23° C. and 65% relative humidity. The measurement was repeated three times, and the laminate strength was determined by calculating the average.

### (Raw Material Resins)

Details of polypropylene resins PP-1 to PP-6 used as raw materials in the following Examples and Comparative Examples are shown in Table 1.

An anti-blocking agent masterbatch (hereinafter, referred to as “MB-1”) was prepared using PP-3, shown in Table 1, as the polypropylene resin, and any one type of particle from a porous silica particle having an average particle size of 2.9 μm and a pore volume of 1.6 mL/g, a silicone particle without a pore having an average particle size of 2.0 μm, and a crosslinked poly (methyl methacrylate) (PMMA) particle without a pore having an average particle size of 1.4 μm as an anti-blocking agent (AB agent). The types of the anti-blocking agent used in the Examples and the Comparative Examples are shown in Table 1. In each of the Examples and the Comparative Examples, the content of the anti-blocking agent in the MB-1 was 5.0% by mass.

TABLE 1

| | PP-1 | PP-2 | PP-3 | PP-4 | PP-5 | PP-6 |
|---|---|---|---|---|---|---|
| Copolymerization amount of components | 0 | 0 | 0 | 0 | 5.2 | 3 |
| other than propylene (mol %) | | | | | | |
| Copolymerization Component | — | — | — | — | Ethylene | Ethylene |
| | | | | | Butene | |
| MFR (g/10 min) | 7.5 | 2.5 | 5.6 | 3.2 | 6.0 | 7.0 |
| [mmmm] (%) | 98.0 | 98.0 | 98.4 | 93.8 | — | — |
| Tm (° C.) | 169 | 167 | 163 | 159 | 140 | 125 |
| Mw | 240,000 | 320,000 | 300,000 | 310,000 | 250,000 | 220,000 |
| Mn | 64,900 | 82,100 | 54,500 | 58,500 | 49,000 | 84,600 |
| Mw/Mn (—) | 3.7 | 3.9 | 5.5 | 5.3 | 5.1 | 2.6 |
| ΔHc (J/g) | 84 | 75 | 98 | 93 | 53 | 64 |

### Example 1

A blend of 70% by mass of PP-1 and 30% by mass of PP-2 was used for the base layer A. A blend of 26% by mass of PP-3, 20% by mass of PP-4, 50% by mass of PP-5, and 4% by mass of MB-1 was used for the surface layer B. A blend of 25% by mass of PP-3, 70% by mass of PP-4, and 5% by mass of MB-1 was used for the surface layer C.

The raw materials for the base layer A were melted using a 45 mm extruder, the raw materials for the surface layer B was melted using a 25 mm extruder, and the raw materials for the surface layer C was melted using a 20 mm extruder, respectively, at 250° C. The molten resins were then co-extruded from a T-die into a sheet shape, solidified by cooling so that the surface layer B would come into contact with a cooling roll at 30° C., and the sheet was stretched in the longitudinal direction (MD) at 135° C. by 4.5 times. Subsequently, in a tenter, the film was held at both edges in the width direction by clips, preheated at 173° C., and stretched in the width direction (TD) at 164° C. by 8.2 times. The film was then heat-set at 171° C. while relaxing in the width direction (TD) by 6.7%, and a laminated body having a three-layer structure of surface layer B/base layer A/surface layer C was obtained.

The surface of the surface layer B of the obtained laminated body was subjected to corona treatment under a condition of applied current: 0.75A, using a corona treatment machine manufactured by Softal Corona & Plasma GmbH. After that, the resulting film was wound with a winder to obtain a biaxially oriented polypropylene film. The total thickness of the obtained biaxially oriented polypropylene film was 20 μm (thickness of individual layer: surface layer B/base layer A/surface layer C: 1.3 μm/17.7 μm/1.0 μm).

### Examples 2 to 4, Comparative Examples 1 and 2, and Comparative Examples S and 6

Biaxially oriented polypropylene films were obtained in the same manner as in Example 1, except that raw material compositions for the surface layers B were changed as shown in Table 2. In Example 4 and Comparative Example 6, raw material compositions for the surface layers C were also changed as shown in Table 2.

### Example 5

A biaxially oriented polypropylene film was obtained in the same manner as in Example 1, except that corona treatment was further applied to the surface layer C.

### Comparative Example 3

An attempt was made to obtain a biaxially oriented polypropylene film in the same manner as in Example 1, except that the raw materials for the surface layer B were changed as shown in Table 2, that is, the polypropylene resin PP-5 having a melting point of 140° C. was replaced with the polypropylene resin PP-6 having a melting point of 125° C. However, during stretching in the longitudinal direction, a phenomenon occurred in which the film adhered to the stretching roll and the stretching start point became unstable. As a result, uniform stretching could not be conducted, and the biaxially oriented polypropylene film could not be stably produced.

### Comparative Example 4

A biaxially oriented polypropylene film was obtained in the same manner as in Example 1, except that the same raw material composition as in Comparative Example 3 was employed, and the production conditions were changed as shown in Table 2, including lowering the stretching temperature in the longitudinal direction by 10° C. to 125° C.

### Comparative Example 7

A biaxially oriented polypropylene film was produced in the same manner as in Example 1, except that the raw material composition for the base layer A was changed as shown in Table 2, that the polypropylene resin PP-4 having a melting point of 159° C. alone was used as the raw material for the base layer A, and that the production conditions were changed as shown in Table 2.

### Comparative Example 8

A biaxially oriented polypropylene film was obtained in the same manner as in Example 1, except that corona treatment was not applied to the surface layer B.

### Comparative Example 9

A biaxially oriented polypropylene film was obtained in the same manner as in Example 1, except that the anti-blocking agent used in both the surface layer B and the surface layer C was changed from the silica particles to the silicone particles.

### Comparative Example 10

A biaxially oriented polypropylene film was obtained in the same manner as in Example 1, except that the anti-blocking agent used in both the surface layer B and the surface layer C was changed from the silica particles to the crosslinked poly(methyl methacrylate) particles.

The raw material composition and the thickness of each layer of the films of Examples and Comparative Examples and the production conditions of the films are shown in Table 2, and physical properties and the evaluation results of the films of Examples and Comparative Examples are shown in Table 3.

TABLE 2

| | | | | Example | Example | Example | Example | Example | Comparative | Comparative | Comparative |
|---|---|---|---|---|---|---|---|---|---|---|---|
| | | | | 1 | 2 | 3 | 4 | 5 | Example 1 | Example 2 | Example 3 |
| Base | Raw | PP-1 | % by mass | 70 | 70 | 70 | 70 | 70 | 70 | 70 | 70 |
| Layer A | Materials | PP-2 | % by mass | 30 | 30 | 30 | 30 | 30 | 30 | 30 | 30 |
| | | PP-4 | % by mass | 0 | 0 | 0 | 0 | 0 | 0 | 0 | 0 |
| | Thickness | | μm | 17.7 | 17.7 | 17.7 | 17.7 | 17.7 | 17.7 | 17.7 | 17.7 |
| Surface | Raw | PP-3 | % by mass | 26 | 21 | 61 | 25 | 26 | 56 | 0 | 26 |
| Layer B | Materials | PP-4 | % by mass | 20 | 0 | 0 | 17 | 20 | 20 | 6 | 20 |
| | | PP-5 | % by mass | 50 | 75 | 35 | 50 | 50 | 20 | 90 | 0 |
| | | PP-6 | % by mass | 0 | 0 | 0 | 0 | 0 | 0 | 0 | 50 |
| | | MB-1 | % by mass | 4 | 4 | 4 | 8 | 4 | 4 | 4 | 4 |
| | | Type of AB Agent | — | Silica | Silica | Silica | Silica | Silica | Silica | Silica | Silica |
| | | AB Agent Particle Size | μm | 2.9 | 2.9 | 2.9 | 2.9 | 2.9 | 2.9 | 2.9 | 2.9 |
| | | AB Agent Pore Volume | ml/g | 1.6 | 1.6 | 1.6 | 1.6 | 1.6 | 1.6 | 1.6 | 1.6 |
| | | AB Agent Content | ppm by mass | 2000 | 2000 | 2000 | 4000 | 2000 | 2000 | 2000 | 2000 |
| | Thickness | | μm | 1.3 | 1.3 | 1.3 | 1.3 | 1.3 | 1.3 | 1.3 | 1.3 |
| | Corona Surface Treatment | | — | Applied | Applied | Applied | Applied | Applied | Applied | Applied | Applied |
| Surface | Raw | PP-3 | % by mass | 25 | 25 | 25 | 25 | 25 | 25 | 25 | 25 |
| Layer C | Materials | PP-4 | % by mass | 70 | 70 | 70 | 67 | 70 | 70 | 70 | 70 |
| | | MB-1 | % by mass | 5 | 5 | 5 | 8 | 5 | 5 | 5 | 5 |
| | | Type of AB Agent | — | Silica | Silica | Silica | Silica | Silica | Silica | Silica | Silica |
| | | AB Agent Particle Size | μm | 2.9 | 2.9 | 2.9 | 2.9 | 2.9 | 2.9 | 2.9 | 2.9 |
| | | AB Agent Pore Volume | ml/g | 1.6 | 1.6 | 1.6 | 1.6 | 1.6 | 1.6 | 1.6 | 1.6 |
| | | AB Agent Content | ppm by mass | 2500 | 2500 | 2500 | 4000 | 2500 | 2500 | 2500 | 2500 |

| | | | | | | | | | | |
|---|---|---|---|---|---|---|---|---|---|---|
| | Thickness | μm | 1.0 | 1.0 | 1.0 | 1.0 | 1.0 | 1.0 | 1.0 | 1.0 |
| | Corona Surface Treatment | — | Not | Not | Not | Not | Applied | Not | Not | Not |
| | | | applied | applied | applied | applied | | applied | applied | applied |
| Film | Molten Resin Temperature | ° C. | 250 | 250 | 250 | 250 | 250 | 250 | 250 | 250 |
| Formation | Cooling Roll Temperature | ° C. | 30 | 30 | 30 | 30 | 30 | 30 | 30 | 30 |
| Conditions | MD Stretching Ratio | times | 4.5 | 4.5 | 4.5 | 4.5 | 4.5 | 4.5 | 4.5 | 4.5 |
| | MD Stretching Temperature | ° C. | 135 | 135 | 135 | 135 | 135 | 135 | 135 | 135 |
| | TD Stretching Ratio | times | 8.2 | 8.2 | 8.2 | 8.2 | 8.2 | 8.2 | 8.2 | 8.2 |
| | TD Preheating Temperature | ° C. | 173 | 173 | 173 | 173 | 173 | 173 | 173 | 173 |
| | TD Stretching Temperature | ° C. | 164 | 164 | 164 | 164 | 164 | 164 | 164 | 164 |
| | Heat Setting Temperature | ° C. | 171 | 171 | 171 | 171 | 171 | 171 | 171 | 171 |
| | TD Relaxation Ratio | % | 6.7 | 6.7 | 6.7 | 6.7 | 6.7 | 6.7 | 6.7 | 6.7 |
| | Film Formability | — | A | A | A | A | A | A | B | C |

| | | | | Comparative | Comparative | Comparative | Comparative | Comparative | Comparative | Comparative |
|---|---|---|---|---|---|---|---|---|---|---|
| | | | | Example 4 | Example 5 | Example 6 | Example 7 | Example 8 | Example 9 | Example 10 |
| Base | Raw | PP-1 | % by mass | 70 | 70 | 70 | 0 | 70 | 70 | 70 |
| Layer A | Materials | PP-2 | % by mass | 30 | 30 | 30 | 0 | 30 | 30 | 30 |
| | | PP-4 | % by mass | 0 | 0 | 0 | 100 | 0 | 0 | 0 |
| | Thickness | | μm | 17.7 | 17.7 | 17.7 | 17.7 | 17.7 | 17.7 | 17.7 |
| Surface | Raw | PP-3 | % by mass | 26 | 46 | 49.7 | 26 | 26 | 26 | 26 |
| Layer B | Materials | PP-4 | % by mass | 20 | 50 | 0 | 20 | 20 | 20 | 20 |
| | | PP-5 | % by mass | 0 | 0 | 50 | 50 | 50 | 50 | 50 |
| | | PP-6 | % by mass | 50 | 0 | 0 | 0 | 0 | 0 | 0 |
| | | MB-1 | % by mass | 4 | 4 | 0.3 | 4 | 4 | 4 | 4 |
| | | Type of AB Agent | — | Silica | Silica | Silica | Silica | Silica | Silicone | PMMA |
| | | AB Agent Particle Size | μm | 2.9 | 2.9 | 2.9 | 2.9 | 2.9 | 2.0 | 1.4 |
| | | AB Agent Pore Volume | ml/g | 1.6 | 1.6 | 1.6 | 1.6 | 1.6 | 0 | 0 |
| | | AB Agent Content | ppm by mass | 2000 | 2000 | 150 | 2000 | 2000 | 2000 | 2000 |
| | Thickness | | μm | 1.3 | 1.3 | 1.3 | 1.3 | 1.3 | 1.3 | 1.3 |
| | Corona Surface Treatment | | — | Applied | Applied | Applied | Applied | Not applied | Applied | Applied |
| Surface | Raw | PP-3 | % by mass | 25 | 25 | 25 | 25 | 25 | 25 | 25 |
| Layer C | Materials | PP-4 | % by mass | 70 | 70 | 74.7 | 70 | 70 | 70 | 70 |
| | | MB-1 | % by mass | 5 | 5 | 0.3 | 5 | 5 | 5 | 5 |
| | | Type of AB Agent | — | Silica | Silica | Silica | Silica | Silica | Silicone | PMMA |
| | | AB Agent Particle Size | μm | 2.9 | 2.9 | 2.9 | 2.9 | 2.9 | 2.0 | 1.4 |
| | | AB Agent Pore Volume | ml/g | 1.6 | 1.6 | 1.6 | 1.6 | 1.8 | 0 | 0 |
| | | AB Agent Content | ppm by mass | 2500 | 2500 | 150 | 2500 | 2500 | 2500 | 2500 |

| | | | | | | | | | |
|---|---|---|---|---|---|---|---|---|---|
| | Thickness | μm | 1.0 | 1.0 | 1.0 | 1.0 | 1.0 | 1.0 | 1.0 |
| | Corona Surface Treatment | — | Not | Not | Not | Not | Not | Not | Not |
| | | | applied | applied | applied | applied | applied | applied | applied |
| Film | Molten Resin Temperature | ° C. | 250 | 250 | 250 | 250 | 250 | 250 | 250 |
| Formation | Cooling Roll Temperature | ° C. | 40 | 30 | 30 | 30 | 30 | 30 | 30 |
| Conditions | MD Stretching Ratio | times | 4.5 | 4.5 | 4.5 | 4.5 | 4.5 | 4.5 | 4.5 |
| | MD Stretching Temperature | ° C. | 125 | 135 | 135 | 135 | 135 | 135 | 135 |
| | TD Stretching Ratio | times | 8.2 | 8.2 | 8.2 | 8.2 | 8.2 | 8.2 | 8.2 |
| | TD Preheating Temperature | ° C. | 167 | 173 | 173 | 168 | 173 | 173 | 173 |
| | TD Stretching Temperature | ° C. | 163 | 164 | 164 | 155 | 164 | 164 | 164 |
| | Heat Setting Temperature | ° C. | 189 | 171 | 171 | 165 | 171 | 171 | 171 |
| | TD Relaxation Ratio | % | 6.7 | 6.7 | 6.7 | 6.7 | 6.7 | 6.7 | 6.7 |
| | Film Formability | — | A | A | A | A | A | A | A |

TABLE 3

| | | | Example | Example | Example | Example | Example | Comparative | Comparative | Comparative |
|---|---|---|---|---|---|---|---|---|---|---|
| | | | 1 | 2 | 3 | 4 | 5 | Example 1 | Example 2 | Example 3 |
| Film | Thickness | μm | 20 | 20 | 20 | 20 | 20 | 20 | 20 | 20 |
| Physical | Haze | % | 2.4 | 2.8 | 2.1 | 4.2 | 2.4 | 1.9 | 4.5 | — |
| Properties | Appearance | — | A | A | A | A | A | A | B | B |
| | Tensile Modulus (MD) | GPa | 2.0 | 2.1 | 2.1 | 2.0 | 2.0 | 2.5 | 2.6 | — |
| | Tensile Modulus (TD) | GPa | 4.0 | 3.9 | 4.3 | 4.0 | 4.0 | 4.9 | 4.5 | — |
| | Sum of Tensile Moduli | GPa | 6.0 | 6.0 | 6.4 | 6.0 | 6.0 | 7.4 | 7.1 | — |
| | Heat Shrinkage Rate at 150° C. (MD) | % | 4.3 | 4.4 | 4.1 | 4.4 | 4.3 | 4.8 | 4.6 | — |
| | Heat Shrinkage Rate at 150° C. (TD) | % | 7.3 | 7.1 | 6.9 | 7.4 | 7.3 | 5.8 | 7.8 | — |
| | Sum of Heat Shrinkage | % | 11.6 | 11.5 | 11.0 | 11.8 | 11.6 | 10.6 | 12.4 | — |
| | Rates at 150° C. | | | | | | | | | |
| | Wetting Tension (B Layer) | mN/m | 40 | 40 | 40 | 40 | 41 | 40 | 40 | — |
| | Wetting Tension (C Layer) | mN/m | 30 or less | 30 or less | 30 or less | 30 or less | 41 | 30 or less | 30 or less | — |
| | Surface Resistance Value (B Layer) | LogΩ | 15.2 | 15.3 | 15.0 | 15.2 | 15.0 | 15.6 | 15.5 | — |
| | Surface Resistance Value (C Layer) | LogΩ | 15.1 | 15.4 | 15.3 | 15.4 | 15.3 | 15.5 | 15.2 | — |
| | Martens Hardness (B Layer) | N/mm² | 188 | 175 | 199 | 190 | 188 | 250 | 164 | — |
| | Martens Hardness (C Layer) | N/mm² | 280 | 279 | 284 | 281 | 280 | 283 | 290 | — |
| | Three-dimensional | nm | 15 | 19 | 21 | 31 | 17 | 32 | 28 | — |
| | Average Roughness SRa (B Layer) | | | | | | | | | |
| | Three-dimensional | | 36 | 35 | 36 | 44 | 37 | 20 | 47 | — |
| | Average Roughness SRa (C Layer) | nm | | | | | | | | |
| | Anti-blocking Agent | % | 2.5 | 3.2 | 1.0 | 6.8 | 2.5 | 0.0 | 11.0 | — |
| | Fall-off Rate (B Layer) | | | | | | | | | |
| | Anti-blocking Agent | % | 2.4 | 1.9 | 2.8 | 3.0 | 2.7 | 2.5 | 2.4 | — |
| | Fall-off Rate (C Layer) | | | | | | | | | |
| | Dynamic Coefficient of Friction | — | 0.48 | 0.49 | 0.45 | 0.39 | 0.50 | 0.42 | 0.50 | — |
| | (B Layer/C Layer) | | | | | | | | | |
| Processability | Guide Roil Contamination | — | A | A | A | B | A | A | — | — |
| Evaluation | Wrinkles in Film Roil | — | A | A | A | A | A | A | — | — |
| | Coatability (B Layer) | — | A | A | A | A | A | A | — | — |
| | Coatability (C Layer) | — | C | C | C | C | A | C | — | — |
| | Adhesion to | — | A | A | A | A | A | C | — | — |
| | Aluminum Vapor-Deposited Layer | — | | | | | | | | |
| | (B Layer) | | | | | | | | | |
| | Oxygen Transmission Rate of | mL/m²/day/MPa | 22 | 19 | 25 | 28 | 22 | 48 | — | — |
| | Aluminum Vapor-Deposited Film | | | | | | | | | |
| | Laminate Strength (MD) (B Layer) | N/15 mm | 2.9 | 3.0 | 2.7 | 3.0 | 3.1 | 1.3 | — | — |

| | | | Comparative | Comparative | Comparative | Comparative | Comparative | Comparative | Comparative |
|---|---|---|---|---|---|---|---|---|---|
| | | | Example 4 | Example 5 | Example 6 | Example 7 | Example 8 | Example 9 | Example 10 |
| Film | Thickness | μm | 20 | 20 | 20 | 20 | 20 | 20 | 20 |
| Physical | Haze | % | 2.0 | 2.7 | 2.7 | 2.4 | 2.4 | 2.7 | 1.8 |
| Properties | Appearance | — | A | A | A | A | A | A | A |
| | Tensile Modulus (MD) | GPa | 2.2 | 2.4 | 2.4 | 1.9 | 2.0 | 2.4 | 2.3 |
| | Tensile Modulus (TD) | GPa | 4.3 | 4.8 | 4.8 | 3.8 | 4.0 | 4.8 | 4.3 |
| | Sum of Tensile Moduli | GPa | 6.5 | 7.2 | 7.2 | 5.7 | 6.0 | 7.2 | 6.6 |
| | Heat Shrinkage Rate at 150° C. (MD) | % | 4.7 | 4.2 | 4.2 | 10. | 4.3 | 4.2 | 4.5 |
| | Heat Shrinkage Rate at 150° C. (TD) | % | 6.3 | 7.3 | 7.3 | 18.4 | 7.3 | 7.3 | 6.6 |
| | Sum of Heat Shrinkage | % | 11.0 | 11.5 | 11.5 | 28.5 | 11.6 | 11.5 | 11.1 |
| | Rates at 150° C. | | | | | | | | |
| | Wetting Tension (B Layer) | mN/m | 41 | 41 | 41 | 42 | 30 or less | 41 | 41 |
| | Wetting Tension (C Layer) | mN/m | 30 or less | 30 or less | 30 or less | 30 or less | 30 or less | 30 or less | 30 or less |
| | Surface Resistance Value (B Layer) | LogΩ | 15.8 | 15.3 | 15.3 | 15.9 | 15.2 | 15.3 | 16.1 |
| | Surface Resistance Value (C Layer) | LogΩ | 15.4 | 15.1 | 15.5 | 15.4 | 15.5 | 15.4 | 15.4 |
| | Martens Hardness (B Layer) | N/mm² | 170 | 278 | 182 | 231 | 188 | 210 | 235 |
| | Martens Hardness (C Layer) | N/mm² | 285 | 280 | 280 | 295 | 280 | 280 | 281 |
| | Three-dimensional | nm | 15 | 19 | 9 | 50 | 15 | 19 | 60 |
| | Average Roughness SRa (B Layer) | | | | | | | | |
| | Three-dimensional | | 38 | 36 | 9 | 84 | 38 | 36 | 67 |
| | Average Roughness SRa (C Layer) | nm | | | | | | | |
| | Anti-blocking Agent | % | 11.0 | 0.8 | 1.1 | 7.8 | 2.5 | 76.0 | 50.0 |
| | Fall-off Rate (B Layer) | | | | | | | | |
| | Anti-blocking Agent | % | 5.2 | 2.2 | 0.7 | 2.4 | 2.2 | 18.9 | 20.2 |
| | Fall-off Rate (C Layer) | | | | | | | | |
| | Dynamic Coefficient of Friction | — | 0.47 | 0.49 | 1 or more | 0.47 | 0.40 | 0.49 | 0.49 |
| | (B Layer/C Layer) | | | | | | | | |
| Processability | Guide Roil Contamination | — | B | A | A | A | A | C | C |
| Evaluation | Wrinkles in Film Roil | — | A | A | C | A | A | A | A |
| | Coatability (B Layer) | — | A | A | A | A | C | A | A |
| | Coatability (C Layer) | — | C | C | C | C | C | C | A |
| | Adhesion to | — | B | C | A | A | C | A | A |
| | Aluminum Vapor-Deposited Layer | — | | | | | | | |
| | (B Layer) | | | | | | | | |
| | Oxygen Transmission Rate of | mL/m²/day/MPa | 40 | 58 | 39 | 65 | 86 | 54 | 50 |
| | Aluminum Vapor-Deposited Film | | | | | | | | |
| | Laminate Strength (MD) (B Layer) | N/15 mm | 2.9 | 1.1 | 2.9 | 2.7 | 1.0 | 2.9 | 3.1 |

The biaxially oriented polypropylene films obtained in Examples 1 to 5 exhibited low levels of guide roll contamination during post-processing, the obtained film rolls exhibited slight wrinkling, and the films taken from the film rolls showed slight repelling of the coating liquid on the layers B. When the aluminum vapor-deposited layer was formed on each of the biaxially oriented polypropylene films, the film exhibited high adhesion to the aluminum vapor-deposited layer, and the resulting aluminum vapor-deposited film showed excellent gas barrier properties due to low oxygen transmission rate. Furthermore, when the unstretched polyethylene film was laminated on each of the biaxially oriented polypropylene films, the laminate strength of the films was high.

In contrast, since the film of Comparative Example 1 contained a small amount of the polypropylene resin having a melting point of 130° C. or higher and 158° C. or lower in the surface layer B, the film exhibited low laminate strength. Furthermore, when the aluminum vapor-deposited layer was provided on the surface layer B, the film exhibited inferior adhesion to the aluminum vapor-deposited layer, and the resulting aluminum vapor-deposited film showed inferior gas barrier properties due to high oxygen transmission rate.

Since the film of Comparative Example 2 contained a large amount of the polypropylene resin having a melting point of 130° C. or higher and 158° C. or lower in the surface layer B, stretching in the longitudinal direction was unstable, and the film exhibited inferior film formability. In addition, the biaxially oriented polypropylene film showed poor appearance due to stretching irregularities that occurred on the longitudinal stretching roll. Accordingly, although the physical properties of the biaxially oriented polypropylene film were measured, the processability of lamination, coating, and vapor deposition processes, was not evaluated, since extremely poor results were anticipated.

Since the film of Comparative Example 3 contained the polypropylene resin PP-6 having a melting point of 125° C., instead of the polypropylene resin PP-5 having a melting point of 140° C., which was used in the resin composition constituting the surface layer B in Example 1, longitudinal stretching was even less unstable than that in Comparative Example 2, and the film exhibited inferior film formability. Because the biaxially oriented polypropylene film was not stably produced, and the film exhibited severely deteriorated appearance due to a large number of stretching irregularities that had occurred on the longitudinal stretching roll, the physical properties and the processability of the biaxially oriented polypropylene film were not evaluated.

The biaxially oriented polypropylene film of Comparative Example 4 was obtained by lowering the longitudinal stretching temperature, in contrast to Comparative Example 3. However, when the aluminum vapor-deposited layer was formed on the surface layer B, the film exhibited low adhesion to the aluminum vapor-deposited layer, and the resulting aluminum vapor-deposited film showed low gas barrier properties due to high oxygen transmission rate.

Since the film of Comparative Example 5 did not contain the polypropylene resin having a melting point of 130° C. or higher and 158° C. or lower in the surface layer B, the film exhibited low laminate strength. Furthermore, when the aluminum vapor-deposited layer was provided on the surface layer B, the film exhibited low adhesion to the aluminum vapor-deposited layer, and the resulting aluminum vapor-deposited film showed significantly low gas barrier properties due to extremely high oxygen transmission rate.

Since the film of Comparative Example 6 contained a small amount of the anti-blocking agent in both the surface layer B and the surface layer C, the surface layers had significantly low three-dimensional average roughness, and the film roll exhibited wrinkling when the film was wound into a roll. As a result, workability during aluminum vapor deposition was impaired.

Since, in Comparative Example 7, polypropylene resin having a melting point of 159° C. was used as a raw material of the base layer A, the sum of the heat shrinkage rates at 150° C. of the film was high. Due to high heat shrinkage rates at 150° C., the barrier properties of the aluminum vapor-deposited layer were decreased when an aluminum vapor-deposited layer was formed on the surface layer B, and the resulting aluminum vapor-deposited film exhibited extremely low gas barrier properties.

Since corona treatment was not applied to the surface layer B, the film of Comparative Example 8 exhibited low laminate strength. Furthermore, when the coating layer was formed on the surface layer B, repelling of the coating layer was observed. In addition, when an aluminum vapor-deposited layer was formed on the surface layer B, the film exhibited low adhesion to the aluminum vapor-deposited layer, and the resulting aluminum vapor-deposited film showed significantly low gas barrier properties due to extremely high oxygen transmission rate.

Since, in Comparative Examples 9 and 10, the anti-blocking agent with zero pore volume was used in both the surface layer B and the surface layer C, the fall-off rates of the anti-blocking agent in the surface layer B and the surface layer C were high, and contamination was observed over the entire surface of the guide roll as a result. Furthermore, when the aluminum vapor-deposited layer was formed on the surface layer B of each film, the resulting aluminum vapor-deposited films exhibited inferior gas barrier properties due to high oxygen transmission rates.

### INDUSTRIAL APPLICABILITY

The biaxially oriented polypropylene film of the present invention exhibits high thermal dimensional stability and excellent mechanical strength. Furthermore, the film exhibits enhanced workability when a vapor-deposited layer or a coating layer is formed on the film, as well as high adhesion to the layers. Accordingly, the biaxially oriented polypropylene film can be suitably used as a base film for various processing applications. Particularly, the biaxially oriented polypropylene film of the present invention is desirable because a film with high gas barrier properties can be obtained when a layer of metal and/or metal oxide is provided on the film. The processed film can be used for food packaging, labels, and industrial applications; hence, the film is industrially useful.

1. A biaxially oriented polypropylene film comprising:
a base layer A containing a polypropylene resin composition; and
a surface layer B containing a polypropylene resin composition provided on one surface of the base layer A,
wherein the film satisfies the following (1) to (4):
(1) a Martens hardness of the surface layer B is 248 N/mm² or less;
(2) a wetting tension of the surface layer B is 36 mN/m or more;
(3) a sum of a heat shrinkage rate at 150° C. in a longitudinal direction and a heat shrinkage rate at 150° C. in a width direction is 0.0% or more and 25.0% or less; and
(4) a fall-off rate of an anti-blocking agent in the surface layer B is 10% or less.

2. The biaxially oriented polypropylene film according to claim 1, wherein the surface layer B has a surface resistance value of 14.0 Log Ω or more.

3. The biaxially oriented polypropylene film according to claim 1, wherein the surface layer B has a three-dimensional average roughness SRa of 10 nm or more.

4. The biaxially oriented polypropylene film according to claim 1, wherein the surface layer B contains a polypropylene resin having a melting point of 130° C. or higher and 158° C. or lower in an amount of 25% by mass or more and 85% by mass or less.

5. The biaxially oriented polypropylene film according to claim 1, wherein the film further comprises a surface layer C on the other surface of the base layer A, and the surface layer C contains a polypropylene resin composition containing an anti-blocking agent.

6. The biaxially oriented polypropylene film according to claim 5, wherein the surface layer C has a three-dimensional average roughness SRa of 15 nm or more and a fall-off rate of the anti-blocking agent in the surface layer C is 10% or less.

7. The biaxially oriented polypropylene film according to claim 5, wherein the surface layer C has a wetting tension of 36 mN/m or more.

8. A laminated body comprising the biaxially oriented polypropylene film according to claim 1 and a functional layer provided on the surface layer B of the film.

9. A laminated body comprising the biaxially oriented polypropylene film according to claim 1 and an unstretched polyolefin film.

10. A laminated body further comprising an unstretched polyolefin film provided on the functional layer of the laminated body according to claim 8.
